(19) United States
(12) Patent Application Publication
(10) Pub. No.: US 2019/0138295 A1
(43) Pub. Date: May 9, 2019

(54) DELIVERY OF FIRMWARE UPDATES IN A LOW-POWER MESH NETWORK

(71) Applicant: Intel Corporation, Santa Clara, CA (US)

(72) Inventors: Mats Agerstam, Portland, OR (US); Sindhu Pandian, Hillsobor, OR (US); Shubhangi Rajasekhar, San Jose, CA (US); Mateo Guzman, Hillsboro, OR (US); Yatish Mishra, Tempe, AZ (US); Pranav Sanghadia, Chandler, AZ (US); Troy Willes, Gilbert, AZ (US); Cesar Martinez-Spessot, Cordoba (AR); Lakshmi Talluru, Chandler, AZ (US)

(21) Appl. No.: 16/235,842

(22) Filed: Dec. 28, 2018

(51) Int. Cl. G06F 8/65; H04L 29/08; H04L 12/66; H04L 12/751; H04L 12/733; H04L 12/24

(52) U.S. Cl. CPC G06F 8/65; H04L 67/34; H04L 67/125; H04L 41/0893; H04L 12/66; H04L 45/02; H04L 45/122; H04L 67/2842

(57) ABSTRACT

In embodiments, an apparatus for selectively delivering software updates to nodes in a network includes a receiver to receive a software update and a list of nodes of the network scheduled to receive the software update. In embodiments, the apparatus further includes a device management agent (DMA) to: identify a set of traversals to leaf nodes of the list of nodes necessary to traverse all nodes on the list, and distribute the software updates to the nodes on the list using the set of traversals.

### FIELD

The present invention relates to the technical field of computing, and, in particular, to apparatus, computer readable media and methods related to delivery of firmware updates to selected nodes of mesh networks.

### BACKGROUND

Given the widespread use of low-power wireless Internet of things (IoT) devices for various operations, ensuring that network nodes are regularly provided with necessary firmware updates is important, both to withstand potential threats as well as to ensure operational uptime and efficiency. Conventionally, firmware over the air (FOTA) updates are done in a centralized manner from a device management (DM) backend that pushes firmware packages to each device in a deployment. This approach is network and power inefficient, particularly as regards battery powered sensor nodes. Thus, in the conventional firmware update a root or central node, such as a DM backend, transmits the payload to each node in the network. This often results in a large traffic overhead, which has a potential negative impact on other network traffic, as well as both increased power consumption and completion times.

### BRIEF DESCRIPTION OF THE DRAWINGS

FIG. 1 illustrates an example apparatus coupled to an example mesh network, in accordance with various embodiments.

FIG. 2 is a plot of percentage performance improvement versus mesh tree depth, for a first optimization in accordance with various embodiments.

FIG. 3 illustrates a first example mesh network (Example A), and example dynamic source routing (DSR) table and adjacency matrix for the first example network, in accordance with various embodiments.

FIG. 4 illustrates example traversal paths for the first example mesh network, according to a first optimization, in accordance with various embodiments.

FIG. 5 illustrates the example traversal paths of FIG. 4 according to a second optimization, in accordance with various embodiments.

FIG. 6 illustrates a second example mesh network (Example B), and example dynamic source routing (DSR) table and adjacency matrix for the second example network, in accordance with various embodiments.

FIG. 7 illustrates example traversal paths for the second example mesh network, according to a first optimization, in accordance with various embodiments.

FIG. 8 illustrates the example traversal paths of FIG. 7 as modified according to a second optimization, in accordance with various embodiments.

FIG. 9 illustrates a third example mesh network (Example C), and example dynamic source routing (DSR) table and adjacency matrix for the third example network, in accordance with various embodiments.

FIG. 10 illustrates example traversal paths for the third example mesh network, according to a first optimization, in accordance with various embodiments.

FIG. 11 illustrates the example traversal paths of FIG. 10 as modified according to a second optimization, in accordance with various embodiments.

FIG. 12 illustrates a fourth example mesh network (Example D), and example dynamic source routing (DSR) table and adjacency matrix for the third example network, in accordance with various embodiments.

FIG. 13 illustrates example traversal paths for the fourth example mesh network, according to a first optimization, in accordance with various embodiments.

FIG. 14 illustrates the example traversal paths of FIG. 13 as modified according to a second optimization, in accordance with various embodiments.

FIG. 15 illustrates a fifth example mesh network (Example E), and example dynamic source routing (DSR) table and adjacency matrix for the fourth example network, in accordance with various embodiments.

FIG. 16 illustrates example traversal paths for the fifth example mesh network, according to a first optimization, in accordance with various embodiments.

FIG. 17 illustrates the example traversal paths of FIG. 16 as modified according to a second optimization, in accordance with various embodiments.

FIG. 18 illustrates two first iterations of an example process for iteratively generating an improved routing table, using the fourth example mesh network (Example D) as an example, in accordance with various embodiments.

FIG. 19 illustrates two last iterations of the example process shown in FIG. 18, and the improved routing table from the fourth iteration, further modified according to a second optimization, in accordance with various embodiments.

FIG. 20A illustrates an overview of the operational flow of a process for receiving a software update and a list of nodes, identifying a set of traversals to leaf nodes to traverse all of the listed nodes, and distributing the software update using the set of traversals, in accordance with various embodiments.

FIG. 20B illustrates an overview of the operational flow of a detailed process for identifying optimized traversal paths in the process of FIG. 20A;

FIG. 21 illustrates a block diagram of a computer device suitable for practicing the present disclosure, in accordance with various embodiments.

FIG. 22 illustrates an example computer-readable storage medium having instructions configured to practice aspects of the processes of FIGS. 1-20, in accordance with various embodiments.

FIG. 23 illustrates an domain topology for respective internet-of-things (IoT) networks coupled through links to respective gateways, according to an example.

FIG. 24 illustrates a cloud computing network in communication with a mesh network of IoT devices operating as a fog device at the edge of the cloud computing network, according to an example.

FIG. 25 illustrates a block diagram of a network illustrating communications among a number of IoT devices, according to an example.

FIG. 26 illustrates a block diagram for an example IoT processing system architecture upon which any one or more of the techniques (e.g., operations, processes, methods, and methodologies) discussed herein may be performed, according to an example.

### DETAILED DESCRIPTION

In embodiments, an apparatus for selectively delivering software updates to nodes in a network includes a receiver to receive both a software update and a list of nodes of the network that are scheduled to receive the software update. The apparatus further includes a device management agent (DMA), to identify a set of traversals to leaf nodes of the list of nodes necessary to traverse all nodes on the list, and to distribute the software updates to the nodes on the list using the set of traversals.

In embodiments, the set of traversals may include just one traversal of each unique branch in a tree-mesh network. This is referred to below as a first optimization. In some embodiments, the set of traversals may be a minimum set of traversals that traverses each node on the list just once. This option is referred to below as a second optimization.

In embodiments, one or more non-transitory computer-readable storage media includes a set of instructions, which, when executed on a network gateway (NG) coupled to a network of nodes, cause the NG to receive a firmware (FW) update and a list of destination nodes (DNs) that are to receive the FW update. The instructions, when executed, further cause the NG to identify a set of traversals to leaf DNs of the network to traverse all of the DNs, wherein if there are two possible traversals to a DN, the traversal with the fewest hops is included in the set, and to distribute the update to the DNs according to the set of traversals.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), (A) or (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

As used herein, including in the claims, the term “chip” may refer to a physical integrated circuit (IC) on a computer. A chip in the context of this document may thus refer to an execution unit that can be single-core or multi-core technology.

As used herein, including in the claims, the term “processor” may refer to a logical execution unit on a physical chip. A multi-core chip may have several cores. As used herein the term “core” may refer to a logical execution unit containing an Ll (lowest level) cache and functional units. Cores are understood as being able to independently execute programs or threads.

As used herein, the term “firmware” (FW) refers to a software program or set of instructions programmed on a hardware device. It may include programs written by software developers to make hardware devices operate properly. For example, FW may provide necessary instructions for how a device communicates with other devices. As used herein, the term “software” thus includes “firmware.” Common reasons for updating FW include fixing bugs or adding features to the device.

In embodiments, more efficient delivery of software updates to nodes of a low power mesh network, such as, for example, ISA 100.11a, WirelessHart, IEEE 802.15.4e/g, or the like, is facilitated. In embodiments, optimizations over traditional FOTA approaches to distribution of a firmware image to multiple nodes are described. In embodiments, these optimizations may leverage knowledge of the details of an underlying network mesh topology to dramatically reduce the number of packets that need to be sent to distribute the FW to all specified nodes.

In embodiments, an apparatus, such as a device management agent (DMA), identifies a set of traversals from root to leaf nodes to be made so as to traverse all nodes scheduled for the update. Then, in embodiments, the DMA informs all targeted nodes of the FOTA update, putting them into a FOTA-update state. FOTA packets are transmitted to all leaf nodes. In embodiments, intermediate nodes cache each packet that belongs to the FOTA update and reconstitute a FW image once the FOTA transaction has been completed. In embodiments, node to node reliability is provided with link layer retransmission between each pair of nodes in the mesh. Following distribution of the update, the integrity of the FW image is then verified using a standard mechanism (e.g. secure hash algorithm-256 (SHA-256) digest or the like), and upon verification nodes commit the updated image, reboot and return to a normal operational state.

Approaches according to various embodiments result in savings in network traffic, bandwidth and power. For example, power consumption is reduced at each node, and, due to significantly less overall traversals to nodes, the time to complete a FW update over a network may significantly be reduced. In embodiments where the mesh network is a wireless sensor network (WSN), a larger scale for the WSN may be provided through optimized use of the spectrum.

Processes in accordance with various embodiments are agnostic to wireless network technology, including both routing processes as well as contention and contention-free systems. Example processes may operate across various DM solutions to support FOTA through batch and DM-agent support at a gateway/edge layer. Processes according to various embodiments apply to both FOTA binary replacement techniques, and also to binary patching techniques, where a differential patch of FW, as opposed to an entire update, are sent to end nodes to regenerate a new firmware image.

In embodiments, application layer protocols used may be either proprietary, or, for example, based on standards, such as LWM2M, OCF, OPAF or OPC-UA, for example. A transport protocol may be transport connect protocol (TCP), or, due to limitations of sensor nodes, user datagram protocol (UDP), for example.

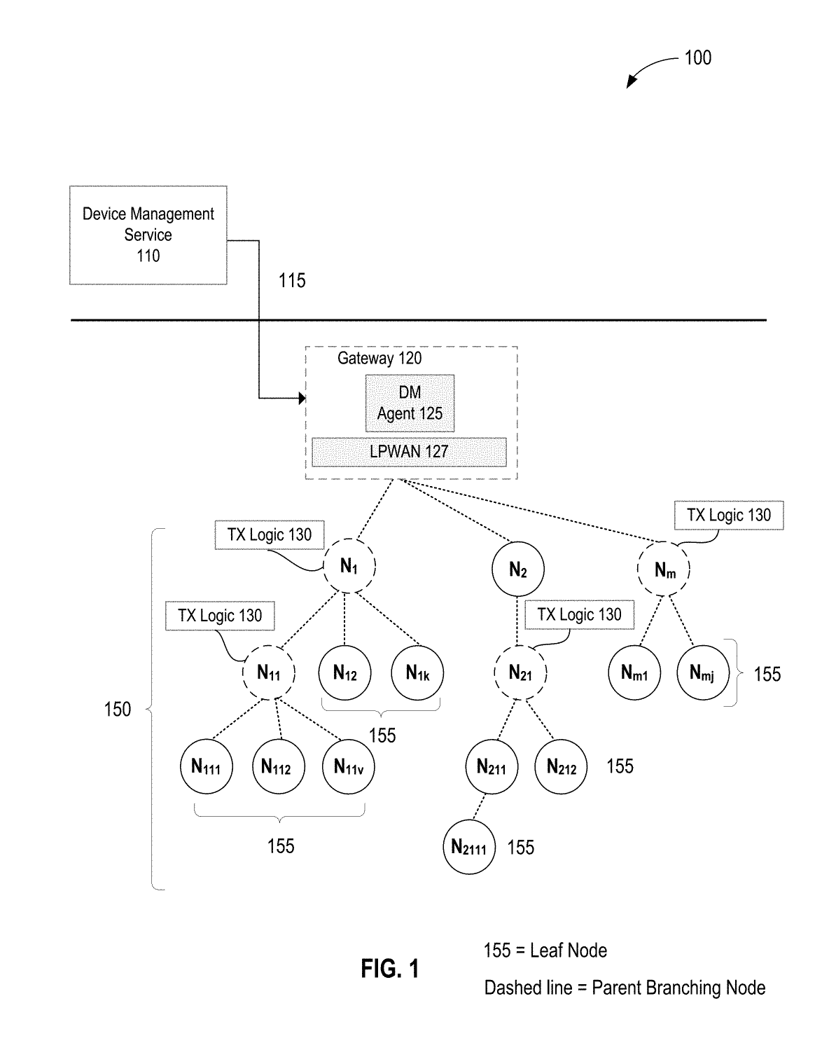

FIG. 1 illustrates an example apparatus 120 coupled to an example mesh network 150, in accordance with various embodiments. Apparatus 120 may, as shown, be a gateway to example network 150. As shown, example network 150 is a tree-mesh network, where there are no loops, and thus every child node has exactly one parent. Tree-mesh network 150 has four “generations” of nodes, on three separate branches, as shown, where nodes N1, N2 and N3 are each nodes at the start or “top” of a different branch. A node that has one or more child nodes is referred to as an “intermediate node.” Given the analogy of networks such as network 150 to trees, a node which has no descendants is referred to as a “leaf node.”

As further shown in FIG. 1, branches N1 and Nm each branch again, having multiple “child” nodes, while branch N2 branches in the third generation, where N21 has two descendants, N211 and N212. N211 has the lone child node of the fourth generation, N2111. Thus, a branch is a set of nodes all descending, directly and indirectly, from a parent node. The parent node from which two or more nodes descend, may thus be referred to herein as a “parent branching node.” Due to the fact that it has descendants, every parent branching node is also an intermediate node. In FIG. 1, all parent branching nodes, including gateway 120, are shown with a dashed line around them. Moreover, as described in detail below, according to a second optimization, a parent branching node performs additional responsibilities, and thus requires additional logic. This is shown in FIG. 1, for example, at parent branching nodes N1, N11, Nm and N21, by TX logic 130. In alternate embodiments, not implementing the second optimization, additional node-based TX logic 130 need not be provided to the parent branching nodes.

In that vein, in implementing the second optimization, it is useful to know which nodes will need additional node-based TX logic 130, and which may not. In some embodiments, for example, it may be centrally known (e.g., by gateway 120) a priori that a parent branching node will always have that status in a network, and in that case such nodes may be provided with the additional logic. However, in other embodiments, the network may reform or change over time (e.g., due to interference or mobile nodes) and network discovery may be required at runtime. In such networks, if the second optimization is desired to be implemented, every node, or every node likely to be a parent branching node as determined by some process, should be provided with TX logic 130.

In alternate embodiments, network 150 may have a mesh topology, where multiple parent nodes are connected to the same child nodes. In embodiments, network 150 is a low-power sensor network.

Continuing with reference to FIG. 1, gateway 120 includes DM agent 125, which is incorporated with the teachings of the present disclosure for efficiently managing the distribution of a software update to select nodes of network 150. Gateway 120 has a northbound connection 115 to device management service (DMS) 110, from which, in embodiments, gateway 120 receives the software update, as well as a list of nodes of network 150 that are to receive it. Gateway 120 also includes low-power wide area network (LPWAN) interface 127, through which DM agent 125 distributes the software update to the list of nodes of network 150. Thus, in embodiments, DM agent 125 supports a batch update of sensor nodes on the list, and is responsible for scheduling and distribution of a FW image to the selected nodes over the LPWAN stack.

Next described are a series of tasks to be performed in a FOTA, in accordance with various embodiments. These tasks are described with reference to FIG. 1. In a first task, a DM management backend, such as, for example, DMS 110, schedules a FOTA for a set of nodes in the network. In embodiments, the nodes may be sensor nodes, and the network may be a low power sensor network, as noted above. In a second task, the DM backend transmits a FOTA command which is received by a gateway agent, such as, for example, DM agent 125 on gateway 120.

In a third task, the DM agent on the gateway performs necessary steps to initiate the FOTA update. These include identifying the optimal routes to use to traverse the network, in the case of network 150, a tree, so as to reach every node in every branch that has nodes that are to be updated, as per the list of nodes received from DMS 110. In general, this requires a route to every leaf node in every branch, which may be referred to as a set of end-nodes, S. In network 150 of FIG. 1, the set of leaf nodes 155 include N111 through N11v, N12 through N1k, N21111 and N212, and on the third branch, Nm1 through Nmj, as shown. IN embodiments, some or all of these leaf nodes 155 may be on the list to receive the FW update. In embodiments, the optimal set of traversals to these leaf nodes is minimal, or near minimal, where each intermediate node on a path to a leaf node is traversed a minimal number of times, and optimally only once.

In embodiments, for source routing, a coordinator, such as DM agent 125, already knows the route to every targeted node when the FOTA update command is received. In dynamic source routing (DSR) embodiments, route discovery may be required prior to issuing the update request.

In a fourth task, the DM agent signals to the targeted set of nodes to transition into a FOTA-Progress state, and then begins transmitting the FOTA image or patch to each of the targeted end-nodes. Each node that is scheduled for the FOTA along the path from the coordinator caches each FOTA package while in FOTA-Progress state. Each intermediary node forwards the packet to targeted child node. In embodiments, any retransmission is managed at the link layer, with a fixed/predetermined number of retries.

In a fifth task, when the FOTA image or patch has been transferred from the coordinator throughout the targeted branches and end-nodes, the coordinator signals a FOTA-Complete-Verify signal to all the nodes in the network. Then, in response, if a binary patching technique is used, each end-node recreates the image using the binary patch file. Moreover, at this point each receiving end-node verifies the integrity of the FW image, such as, for example, by using a SHA-256 checksum. While implementation specific, a node failing to verify the integrity of the FW image silently discards the reconstituted image. In embodiments, authenticity of the FW image is also checked in this step.

In a sixth task, the coordinator issues a FOTA-Complete-Commit to the end nodes, and end node with a successfully verified image commits its image in flash and reboots. IN some embodiments, the coordinator may later query the version and state of nodes to identify any failed updates and then perform a separate scheduled FOTA for those nodes.

As noted above, in a traditional FOTA deployment, each packet is sent from the update coordinator, e.g., DM agent 125, to each node on the list. Next described is an analysis of overall performance improvement according to a first optimization according to various embodiments. The improvement is measured in transactions, which is directly proportional to power savings and airtime optimization.

For the purposes of the following analysis, the following notation is utilized:

t is the number of transactions;

k is the number of branches in the mesh from root; and

the set {n₁, n₂, . . ., nₘ} denotes the number of links/vertices from root to end nodes in each branch.

As noted, in the conventional approach, a packet is sent from a coordinator to each node in each branch of the network, i.e.:

$$T \text{:} t = {\sum }_{i = 1}^{k} {\sum }_{j = 1}^{m} {n}_{ji}$$

which yields,

$$T \text{:} t = 0.5 {\sum }_{i = 1}^{k} ( {n}_{i} + {n}_{i}^{2} )$$

In contrast, in embodiments, each unique branch of the network is traversed at most once for each targeted end node, and thus:

$$O \text{:} t = {\sum }_{i = 1}^{k} {n}_{i}$$

The improvement is given by 1-(O/T). Because the number of branches are the same in both cases, as the same network is used for this comparison, the improvement, I is congruent to the total set of vertices, n:

$$I = 1 - \frac{n}{0.5 n ( 1 + n )} , or simplified$$

$$I = \frac{n - 1}{n + 1}$$

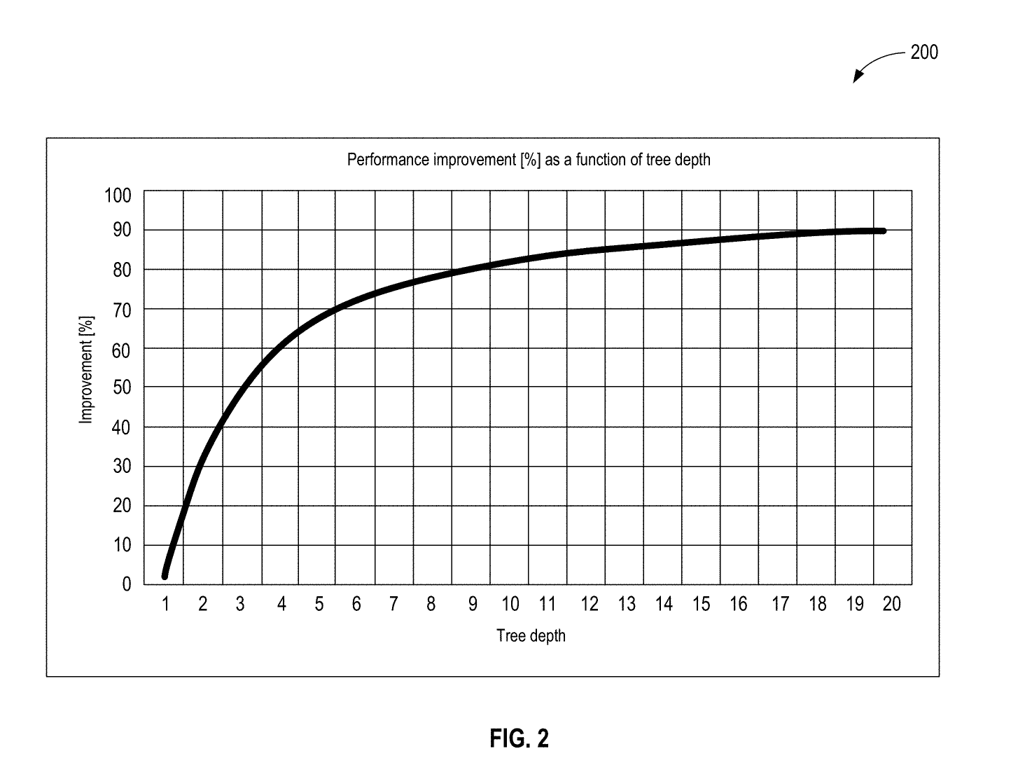

FIG. 2 depicts a plot 200 of percentage performance improvement as a function of tree-mesh depth for a first optimization in accordance with various embodiments. As shown in FIG. 2, the deeper the tree-mesh, e.g., the greater the number of generations in the network, the greater the improvement. This is because, in embodiments according to the first optimization, a unique branch of a tree-mesh network is only traversed once. The deeper the branches, the greater number of repeat traversals to end nodes are avoided. It is here noted that while each unique branch of the network is traversed only once, in embodiments according to the first optimization, a parent branching node, as well as all ancestor nodes to that parent branching node, may be traversed multiple times, once for each unique branch. Thus, for example, with reference to FIG. 1, node N1 may be traversed thrice, for each branch that descends form it, and node N111 may also be traversed thrice, for its three descendant branches. Similarly, node N21 may be traversed twice, and thus, actually, the path N2->N21, twice, to reach each of unique branches N211 and N212. These latter branches, however, are each only traversed once.

In some embodiments, a second optimization, over and above the first optimization described above, is implemented. In this second optimization, each node in a branch that has two or more children (e.g., the node, although in a branch itself, is also a branching parent node) is made responsible for transmitting each FOTA packet it receives to each of its descendant branches that has at least one node targeted for the FOTA. While this second optimization eliminates even more redundant network traffic, it comes with increased node complexity, as next described.

In embodiments that implement the second optimization, each branching parent node needs to know the set of targeted nodes to be updated, as per the list received by gateway 120 from DMS 110, with reference to FIG. 1. More specifically, each parent branching node needs to know which of those nodes on the list are its own descendants. Thus, in embodiments implementing the second optimization requires more involved scheduling strategies in TDM based implementations than those embodiments implementing the first optimization. Additionally, in such embodiments, as also shown in FIG. 1, and as noted above, custom TX logic 130 needs to be provided at each parent branching node over and above the basic store-and-forward logic, with which network nodes are generally provided.

The following describes various tasks performed in a FOTA update according to embodiments implementing the second optimization. A GW signals the start of a FOTA update flow, indicating in the signaling the set of targeted nodes to receive the update. For each branch identified by the GW, it sends out a FOTA packet transmission, as follows. If the branch does not contain a parent branching node, packets are addressed to the leaf directly. For each branch identified, when the GW, or other controller, decides the order in which to send updates to, it starts by selecting the targeted nodes from the bottom, working its way upwards. However, as described below with reference to the five example networks, the flow of the actual software update is always top down, or from GW or other controller to leaf nodes.

At a parent branching node, if the parent node is designated for the update, each packet of the FOTA is cached and the image subsequently reconstructed and verified. If the parent node is not designated for the update, the parent will transfer the packet to all of its descendant leaf nodes.

At an intermediary node that does not branch (e.g., parent node with only one child node), if the node is designated for the update, each packet of the FOTA is cached and the image subsequently reconstructed and verified. If the intermediary node is not designated for the update, the node will transfer the packet to its single child node and discard it, once transmission of the packet has been successful.

Finally, at a leaf node, the node caches the packet and subsequently rebuilds the image at the conclusion of the FOTA flow and verifies it. Once the FOTA flow has completed, the gateway signals to the targeted nodes to rebuild and verify the image before committing the updated FW image.

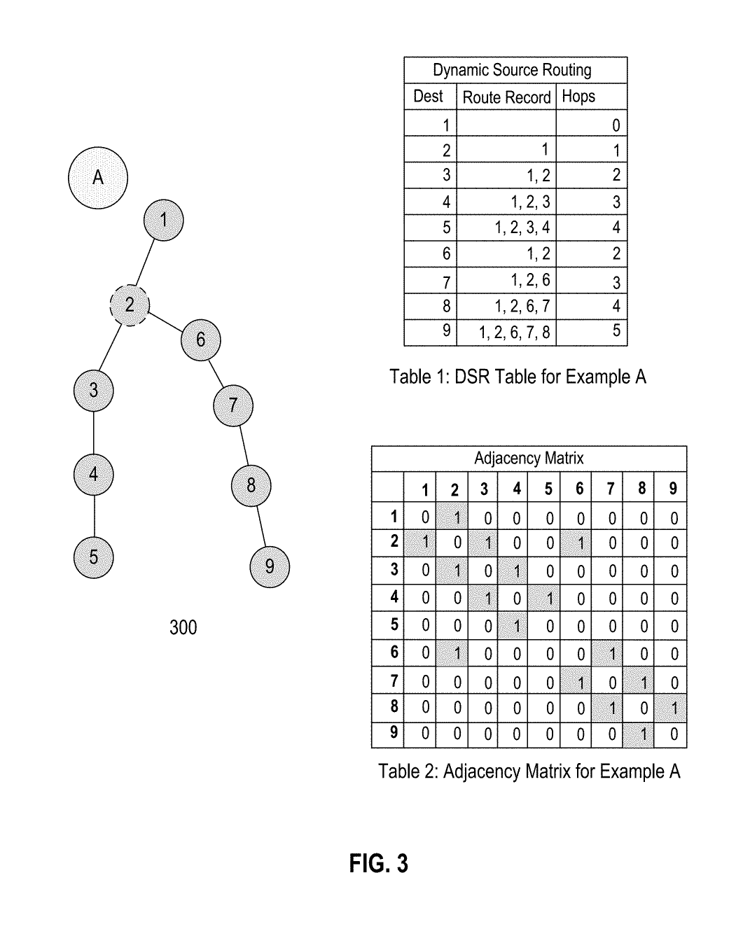

Next described, with reference to FIGS. 3 through 17, are five example mesh networks, an analysis of each network and a calculation of node traversal paths for each example network according to each of the two optimizations described above.

FIG. 3 illustrates a first example network, Example A 300. It is, by inspection, a tree-mesh network, with nine nodes total, including two branches from node 2, a parent branching node (shown with the dashed line circle, as above). It is assumed that all nine nodes are to receive the update, and that the coordinator is node 1. Table 1 of FIG. 3, a dynamic source routing (DSR) table for Example A, illustrates each of the nine node destinations, with the number of hops needed from node 1 to get there. The number of hops is determined, for example, using an adjacency matrix, as shown in Table 2 of FIG. 3. In some embodiments, a coordinator node, such as GW 120 of FIG. 1, is provided with an adjacency matrix, and in others it performs network discovery prior to beginning a FOTA, after receiving the set of nodes to be updated, from, for example, DMS 110 of FIG. 1.

In a conventional FOTA process applied to Example A, the update originates at the root node, node 1, and makes a separate trip to every other node. In terms of hops, and with reference to Table 1, this equals 1+2+3+4 hops on the left side, and 2+3+4+5 hops on the right side, of the network. Overall, this sums to 10 hops (left branch)+14 hops (right branch)=24*N hops for an N-packet transfer. This sum is obtained by adding the rightmost column of Table 1.

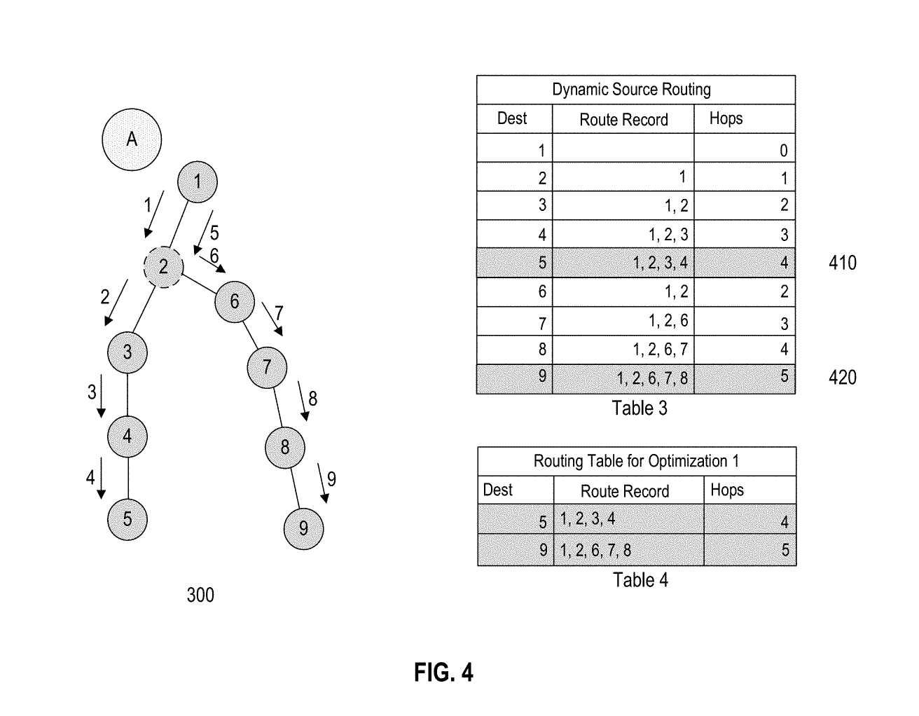

In contrast, as shown in FIG. 4, in embodiments implementing the first optimization, where no separate trip to each listed node is needed, but rather each branch of the network is traversed solely once, the number of hops to complete the transfer is 4 hops on the left branch and 5 hops on the right branch, resulting in 9*N packets of traffic for an N packet update. 3. Thus, in embodiments, only entries 410 and 420 of the DSR table, Table 3, are used, and these are extracted to form a new table, Table 4, which is a routing table for optimization 1, in accordance with various embodiments. By using only these two paths, all nodes in Example A are traversed, with node 2 traversed twice, with reference to FIG. 4, at hop 1 and at hop 5, as shown.

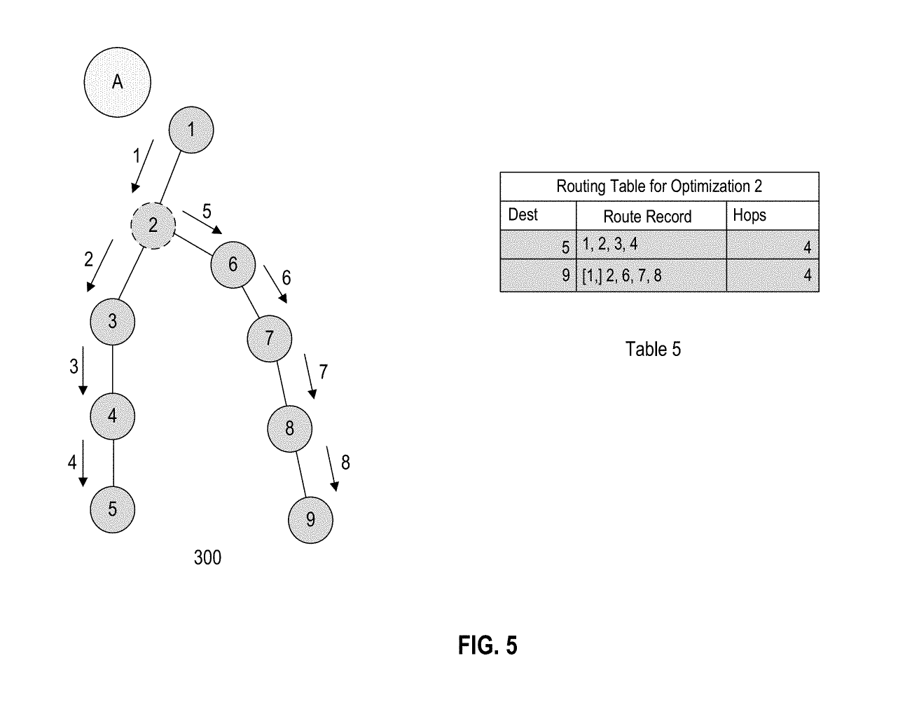

Further, in embodiments applying the second optimization (referred to herein as “fully optimized embodiments”), with reference to FIG. 5, when node 2 is traversed, instructions are provided with the FW update packets to node 2 to pass the update packets onwards to each of its two child branches. As a result, node 2 is only traversed once, resulting in overall network traffic=1 (single hop to node 2)+3 (left branch)+4 (right branch)=8*N, for an N packet update, as shown in Table 5, the routing table for Optimization 2. In Optimization 2 routing tables as presented herein, such as Table 5, bracketed nodes are shown, but are only actually traversed once, in the entries in which they are not shown in brackets. As described above, in fully optimized embodiments, node 2 would be provided with additional TX logic, such as, for example, TX logic 130, shown in FIG. 1, to accomplish this task.

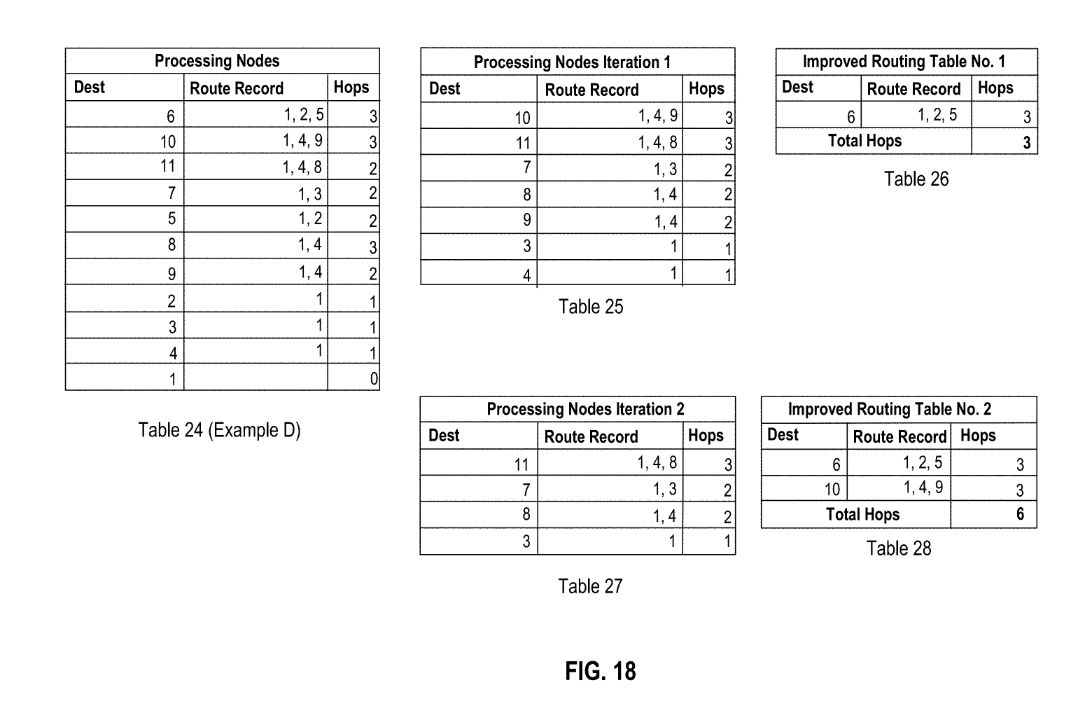

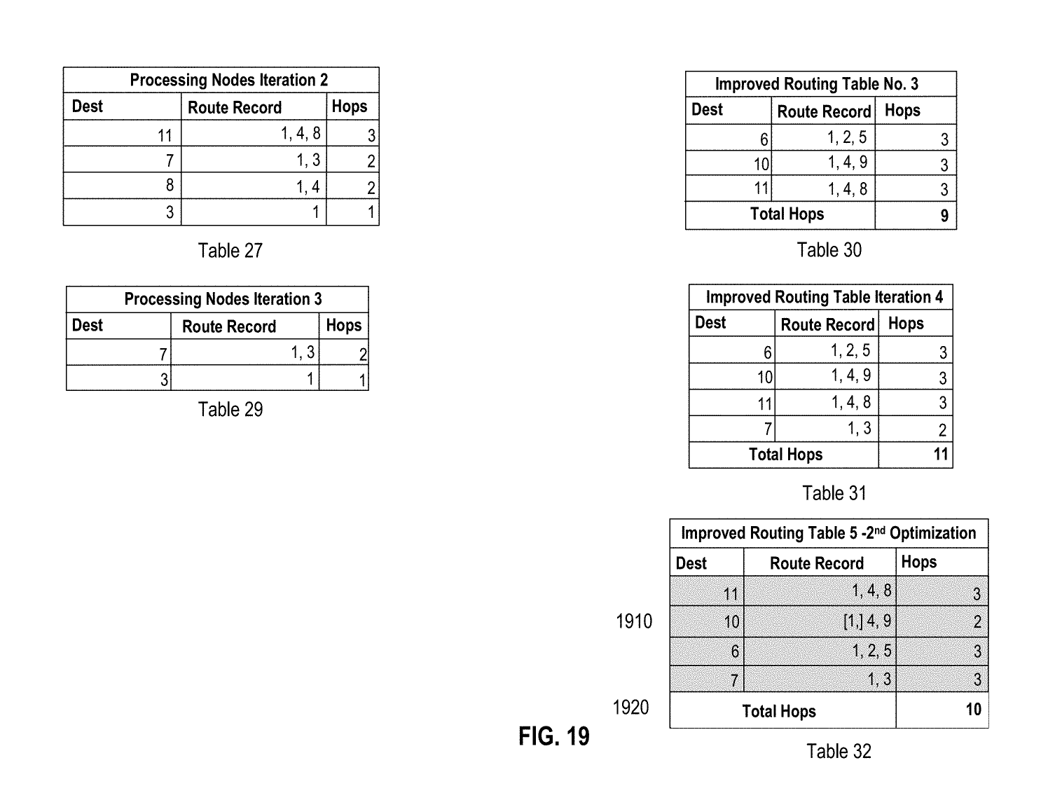

Described below, with reference to FIGS. 18 and 19 are example processes which may be used by a coordinator to obtain an Improvement Routing Table for each of the two optimizations, using a DSR table as an input.

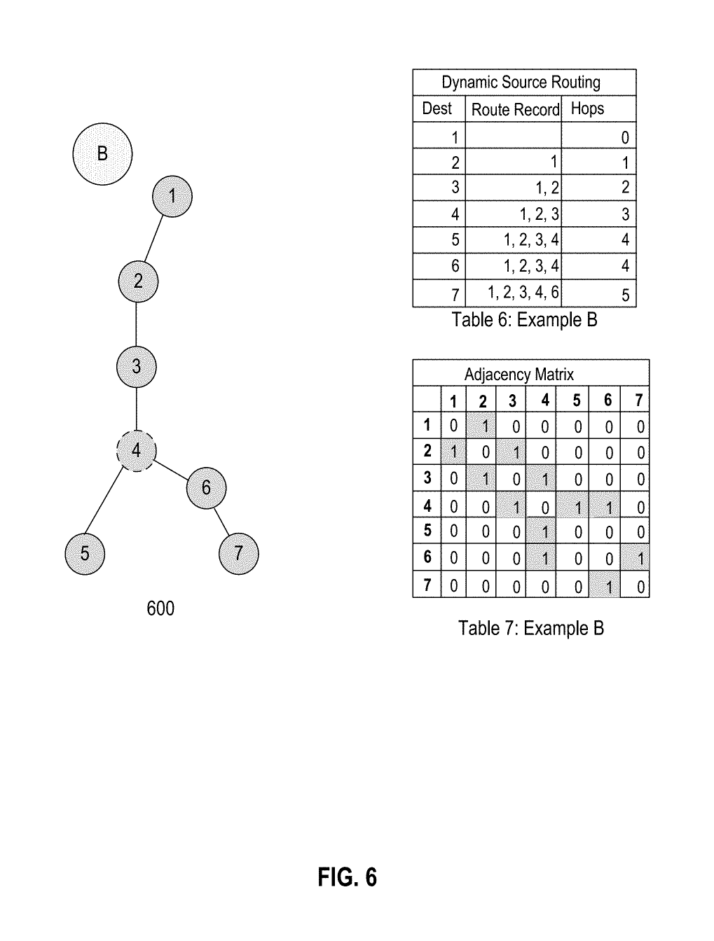

FIG. 6 illustrates a second example network, Example B 600. It is, by inspection, also a tree-mesh network, with seven nodes total, including two branches from node 4, a parent branching node (shown with the dashed line circle, as above). It is assumed that all seven nodes are to receive the update, and that the coordinator is node 1. Table 6 of FIG. 6, a DSR table for Example B, illustrates each of the seven node destinations, with the number of hops needed from node 1 to get there. The number of hops is determined, for example, using an adjacency matrix, as shown in Table 7 of FIG. 6, which gives, for each node, those other nodes that are a single hop away.

In a conventional FOTA process applied to Example B, the update originates at the root node, node 1, and makes a separate trip to every other node. In terms of hops, and with reference to Table 6, this equals 1+2+3+4 hops on the left side, and 4+5 hops on the right side, of the network. Overall, this sums to 10 hops (left branch)+9 hops (right branch)=19*N hops for an N-packet transfer. This sum is obtained by adding the rightmost column of the DSR, here Table 6.

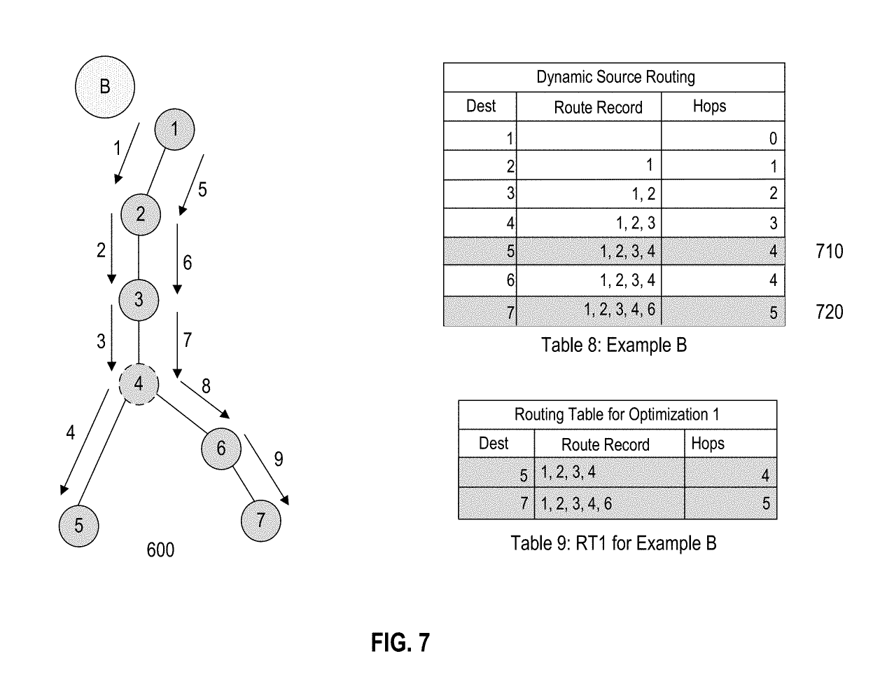

In contrast, as shown in FIG. 7, in embodiments implementing the first optimization, where no separate trip to each listed node is needed, but rather each branch of network 600 is traversed solely once, the number of hops to complete the transfer is 4 hops on the left branch and 5 hops on the right branch, resulting in 9*N packets of traffic for an N packet update. Thus, in embodiments, only entries 710 and 720 of the DSR, Table 8, are used, and these entries are extracted to form Table 9, a routing table for traversing network 600 according to Optimization 1, in accordance with various embodiments. By using only these two paths, all nodes in network 600 are traversed, with nodes 2, 3 and 4 each traversed twice, as shown in FIG. 7, by hops 1, 2, 3, 5, 6 and 7. This is a considerable redundancy of node traversals, however. This is due to the fact that the sole parent branching node of network 600, here node 4, is much closer to the leaf nodes than was the case for network 300 of Example A, described above with reference to FIG. 4.

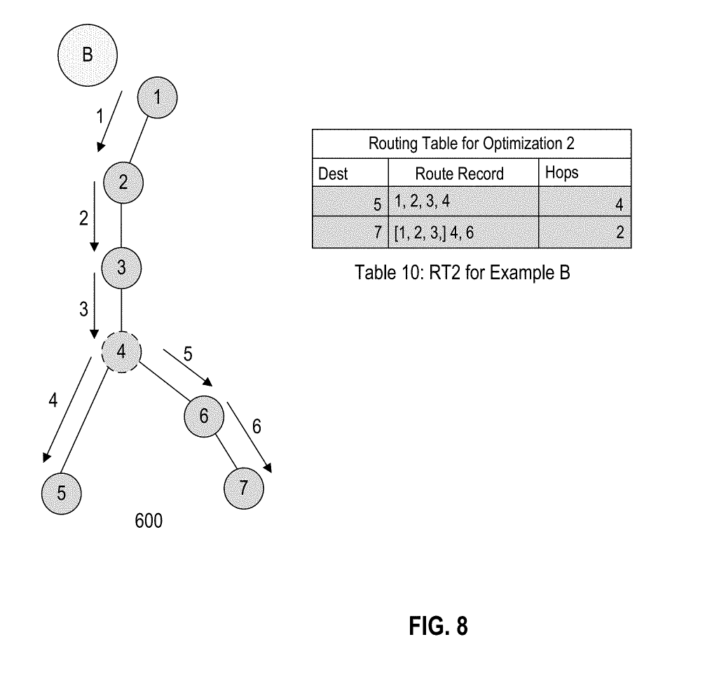

Accordingly, in fully optimized embodiments, with reference to FIG. 8, when node 4 is first traversed, instructions are provided with the FW update packets to node 4 to pass the update packets onwards to each of its two child branches, namely node 5 on the left, and nodes 6 and 7 on the right. As a result, node 4 is only traversed once, resulting in overall network traffic=3 (three hops to node 4)+1 (left branch)+2 (right branch)=6*N, for an N packet update, as shown in Table 10, the routing table for Optimization 2. As described above, in the fully optimized embodiments, node 4 is provided with additional TX logic to accomplish this task.

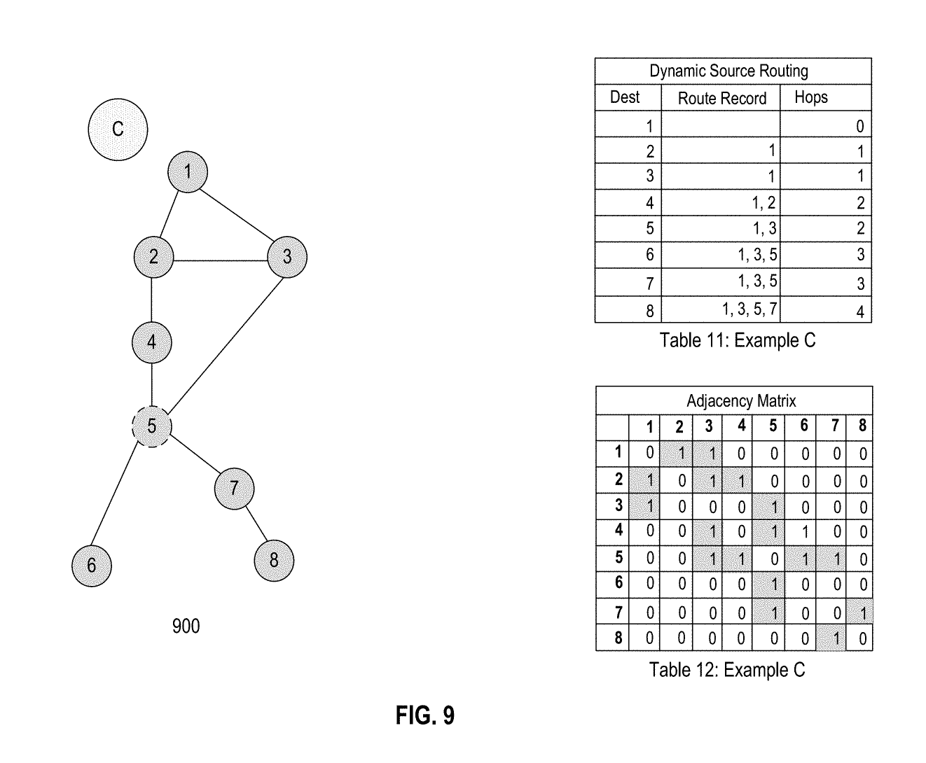

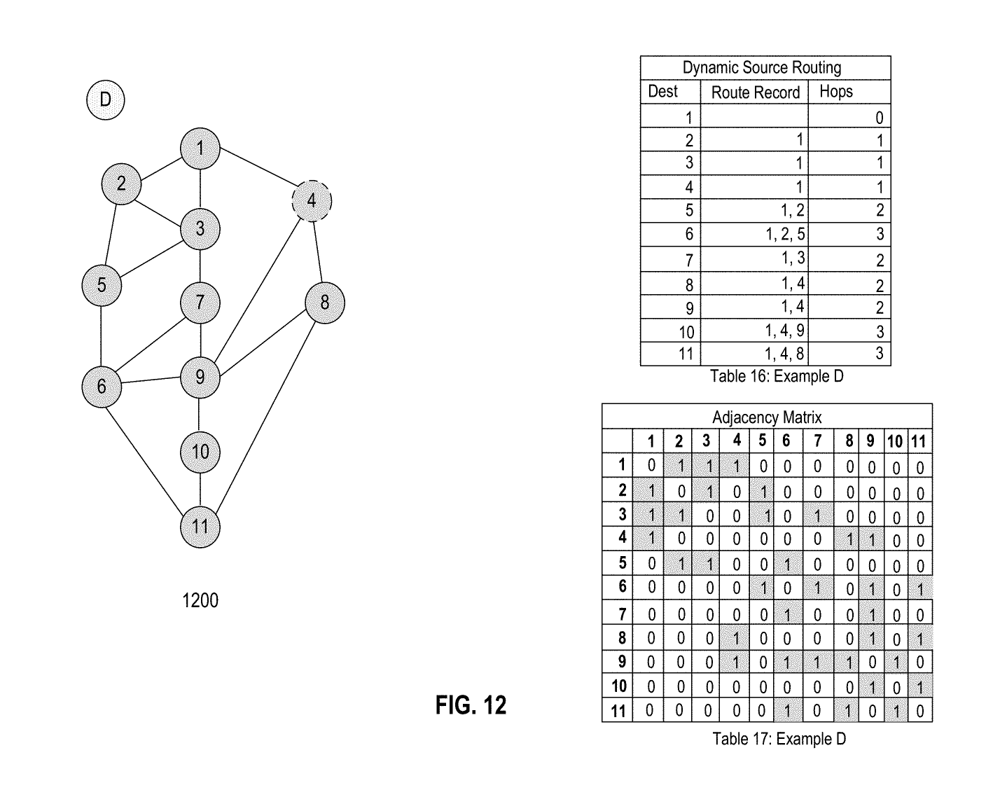

FIG. 9 illustrates a third example network, Example C 900. It is a hybrid mesh network, with eight nodes total, including two branches from node 1, and two branches from node 5. All seven nodes are to receive the update, and are thus all nodes are destination nodes, as shown in Table 11, the DSR for Example C 900. As in all the five example networks presented herein, the coordinator is node 1. Table 11 also shows the number of hops needed to get from node 1 to each of the other nodes, respectively. The number of hops is determined, as in the examples described above, using the adjacency matrix of FIG. 12, which gives, for each node in example network 900, every other node that is a single hop away. Because node 3 is also, in addition to node 4, a parent to node 5, the shortest path to reach node 5 is through node 3.

Thus, in a conventional FOTA process applied to Example C, the update originates at the root node, node 1, and makes a separate trip to every other node, but uses the shortest number of hops to do so. With reference to Table 11, this equals 1+2 hops on the left side to reach each of nodes 2 and 4, 1+2+3 hops, crossing form the left to the right sides of network 900, to reach nodes 3, 5 and 6, and 3+4 hops on the right side of the network to reach nodes 7 and 8. Overall, this sums to 16*N hops for an N-packet transfer. As in the examples above, this sum is obtained by adding the rightmost column of the DSR, here Table 11.

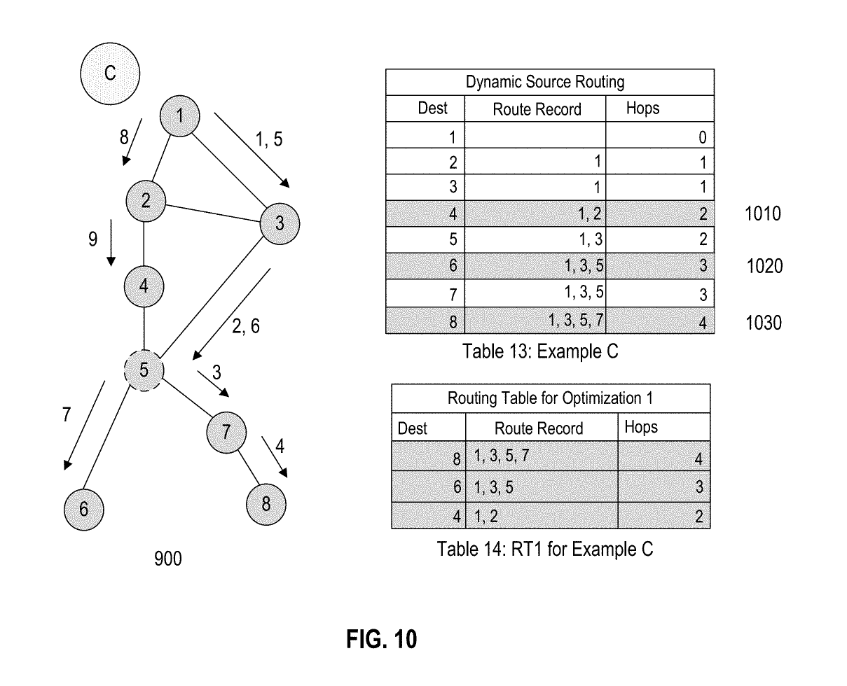

In contrast, as shown in FIG. 10, in embodiments implementing the first optimization, where no separate trip to each listed node is needed, but rather each branch of network 900 is traversed solely once, the number of hops to complete the transfer is 2 hops on the upper left branch comprising nodes 1, 2 and 4, 3 hops on the crossover branch comprising nodes 1, 3, 5 and 7, and 4 hops on the right branch, resulting in 9*N packets of traffic for an N packet update.

Thus, in embodiments, only entries 1010, 1020 and 1030 of the DSR, Table 13, are used, and these entries are extracted to form Table 14, a routing table for traversing network 900 according to Optimization 1, in accordance with various embodiments. By using only these three paths, all nodes in network 900 are traversed, with nodes 3 and 5 each traversed twice, as shown in FIG. 10, by hops 1 and 5 to node 3, and by hops 2 and 6 to node 5, for a total of 9 overall hops.

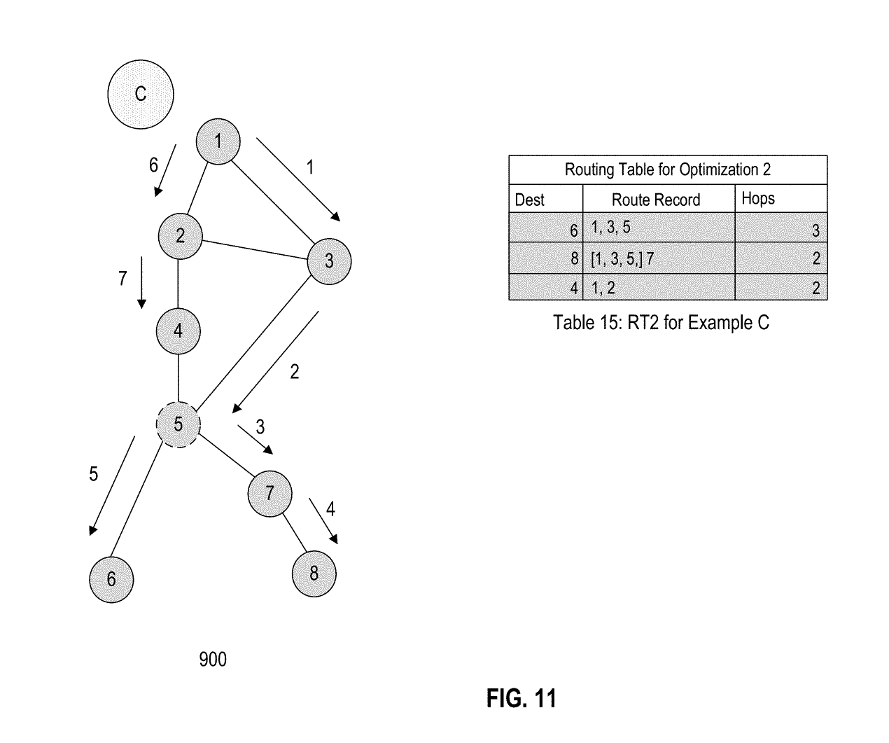

Optimizing the traversal of network 900 even further, in fully optimized embodiments, with reference to FIG. 11, node 5 is identified as a parent branching node. Thus, when node 5 is first traversed, instructions are provided with the FW update packets to node 5 to pass the update packets onwards to each of its two child branches, namely node 6 on the left, and nodes 7 and 8 on the right. As a result, node 5 is only traversed once, resulting in overall network traffic=2 (two hops to node 4)+2 (two hops to node 5)+1 (left branch)+2 (right branch)=7*N, for an N packet update, as shown in Table 15, the routing table for Optimization 2 for network 900. As is the case with every routing table, the sum of the rightmost column of the table, here Table 15, provides the total number of hops. As described above, in fully optimized embodiments, node 5 is provided with additional TX logic to accomplish the forwarding to its respective two branches.

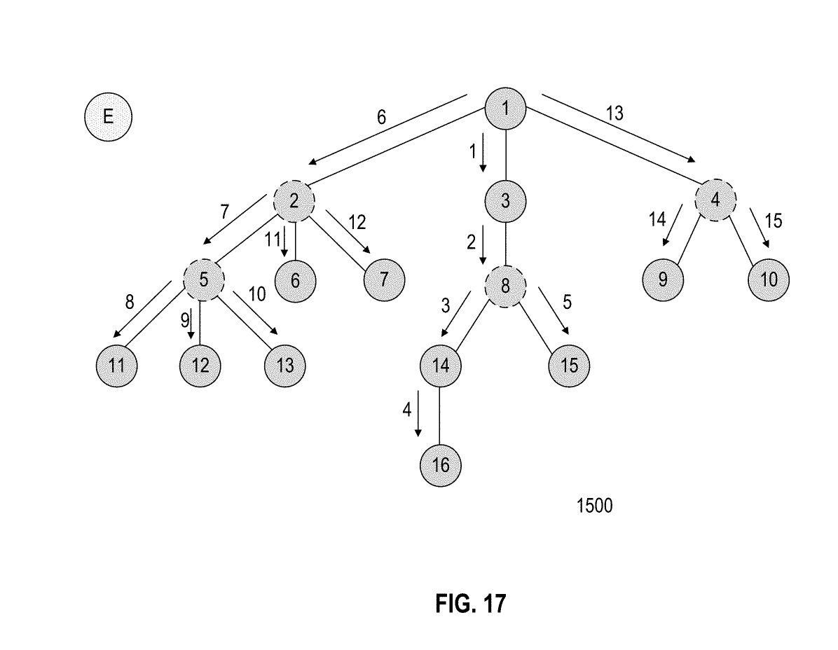

FIG. 12 illustrates a fourth example network, Example D 1200. It is an almost pure mesh network, with eleven total nodes, and several nodes with more than one parent node. All nodes are to receive the update, and are thus all nodes are destination nodes, as shown in Table 16, the DSR for Example D network 1200. As in all the five example networks presented herein, the coordinator is node 1. Table 16 also shows the number of hops needed to get from node 1 to each of the other nodes, respectively. The number of hops is determined, as in the examples described above, using the adjacency matrix of FIG. 17, which gives, for each node in example network 1200, every other node that is a single hop away. With reference to Table 16 it is noted that, given the numerous mutual interconnections, by choosing unique branches, the shortest paths to various nodes may be obtained. Thus, four separate branches or paths are shown. These include a left side branch including nodes 1, 2, 5 and 6, a central branch including nodes 1, 3 and 7 (but not 9-11), a right-central path including nodes 1, 4, 9 and 10, and a right side branch including nodes 1, 4, 8 and 11. Additionally, a shown, for purposes of the second optimization for traversing this network 1200, node 4 may be identified as a parent branching node. This is described in greater detail below.

Thus, in a conventional FOTA process as applied to Example D, the update originates at the root node, node 1, and makes a separate trip to every other node, but uses the shortest number of hops to each destination node to do so. Applying such a traditional method results in 20*N network traffic, for an N packet software update, as follows. The left side branch through nodes 1, 2, 5 and 6 takes N+2N+3N=6N to be updated. Similarly, the right side branch of nodes 1, 4, 8 and 11 takes N+2N+3N=6N to be updated. Additionally, central branch of nodes 1, 3 and 7 takes 1N+2N=3N, and cross-over right-central branch of nodes 1, 4, 9 and 10 also takes N+2N+3N=6N, to be updated, respectively. The end nodes of each of these four branches are chosen to satisfy use of the minimum total hops possible. Thus, the total hops, obtained by adding these sums, which is also obtained by adding the rightmost column of Table 18, yields a total of 20 hops.

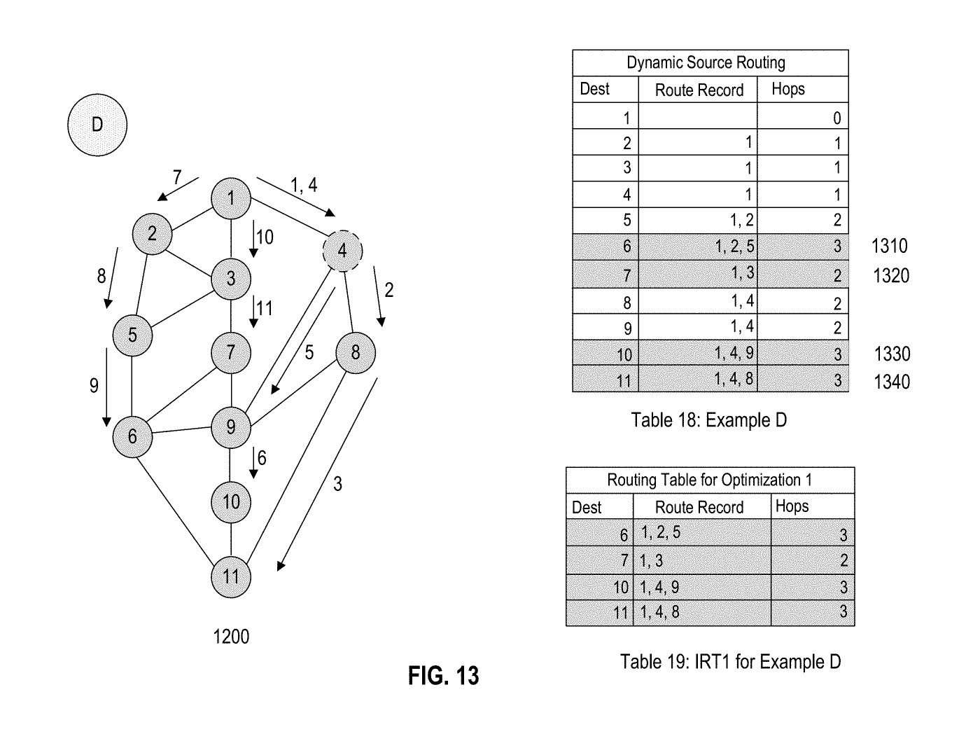

Improving upon this, as shown in FIG. 13, in embodiments implementing the first optimization, where no separate trip to each listed node is needed, but rather where each of the identified four branches of network 1200, as described above, is traversed solely once, from root node to the end node of that branch, the number of hops to complete the transfer is 3 hops on the upper left branch to node 6, 2 hops on the central branch to node 7, 3 hops on the right-central branch to node 10, and 3 hops on the right branch to node 11, for a total of 11*N packets of traffic for an N packet update.

Thus, in such embodiments according to the first optimization, only entries 1310, 1320, 1330 and 1340 of the DSR, Table 18, are used, and these entries are extracted to form Table 19 a routing table for traversing network 1200, Example D, according to Optimization 1, in accordance with various embodiments. By using only these four paths, all nodes in network 1200 are traversed, with node 4 traversed twice, as shown in FIG. 13, by hops 1 and 4 to node 4.

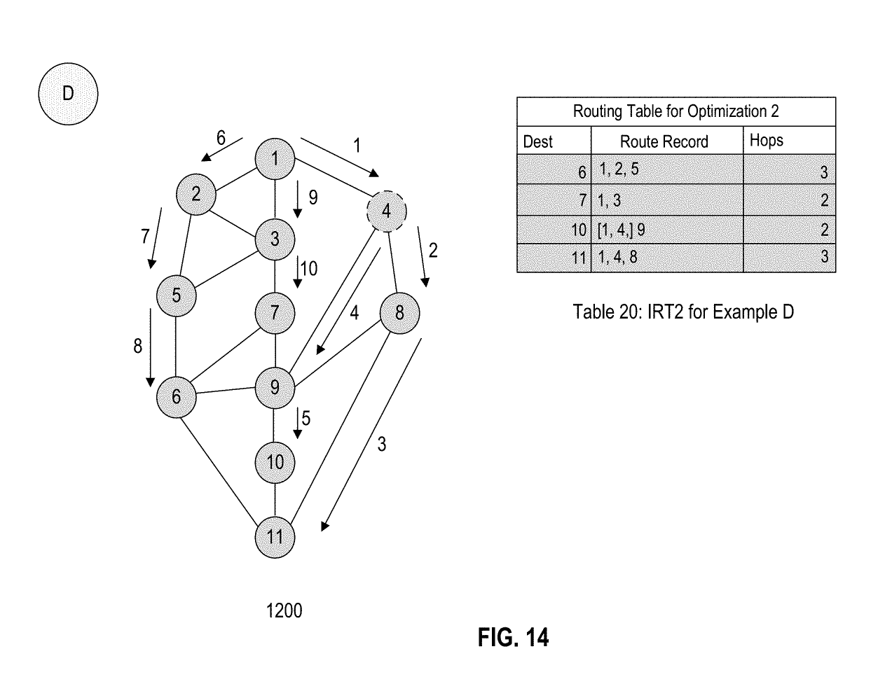

Optimizing the traversal of network 1200 even further, in fully optimized embodiments, with reference to FIG. 14, node 4 is identified as a parent branching node. Thus, the redundant hops to node 4 may be consolidated, and when node 4 is first traversed, instructions are provided with the software update packets to node 4 to pass the update packets onwards to each of its two child branches, namely node 9 on the left, and node 8 on the right. As a result, node 4 is only traversed once, resulting in overall network traffic=3 (three hops to node 6)+2 (two hops to node 7)+3 (right-center branch: three hops to node 10)+2 (right branch: two additional hops form node 4 to node 11)=10*N, for an N packet update, as shown in Table 20, the routing table for Optimization 2 for network 1200. As is the case with every routing table, the sum of the rightmost column of the table, here Table 20, provides the total number of hops, and bracketed nodes in the entries of Table 20 are not traversed a second time. As described above, in fully optimized embodiments, node 4 is provided with additional TX logic to accomplish the forwarding to its respective two branches.

Thus, as shown by Example D, in embodiments, a definite improvement in terms of network traffic, and, therefore, bandwidth usage, power consumption, and time required for the network to be updated, is observed in almost all topologies that are of a star/mesh structure.

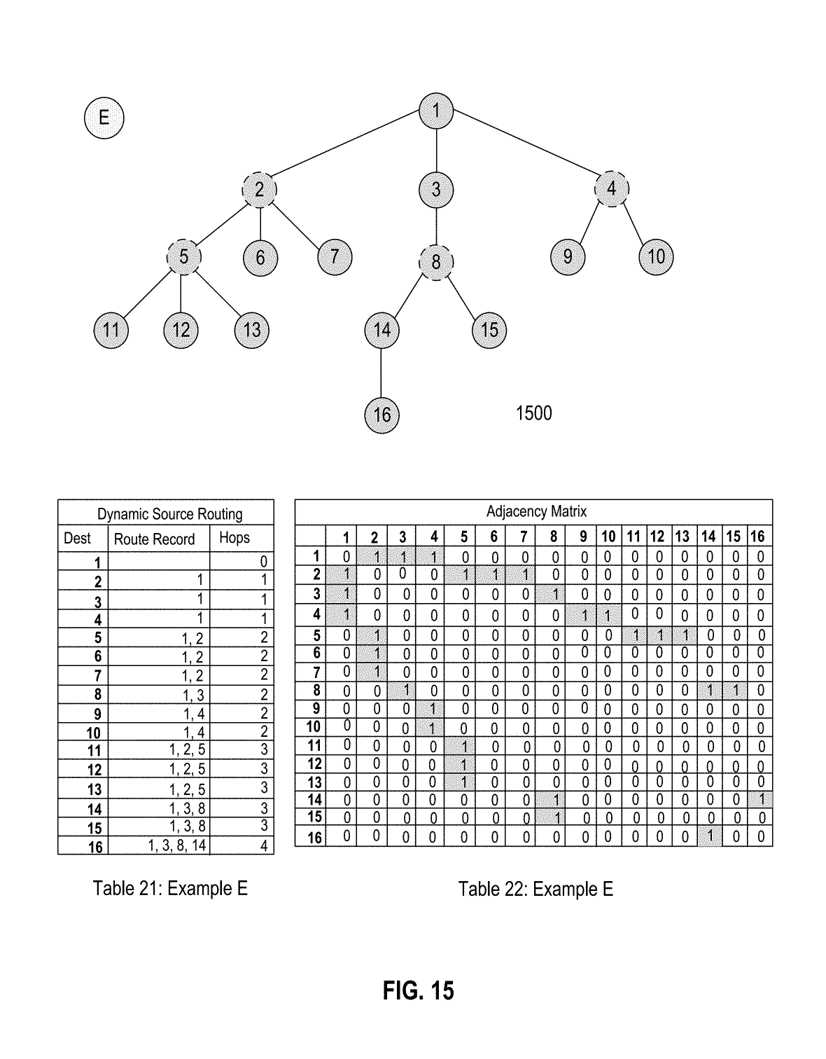

Finally, FIG. 15 illustrates a fifth example network, Example E 1500. It is, by inspection, a five-level tree network, with a total of sixteen nodes, including three branches, and each of the three branches including additional branches. Assuming that all sixteen nodes are to receive the update, with node 1 functioning as the coordinator, Table 21 of FIG. 15, the DSR table for Example E, lists each of the sixteen node destinations, with the number of hops needed from node 1 to get there. The number of hops is determined, for example, using the adjacency matrix shown in Table 22 of FIG. 15, which gives, for each node, all other nodes that are a single hop away. Unlike the more populated adjacency matrix for Example D, a near total mesh network, shown in Table 17 of FIG. 12, because for a pure tree network a given node is only adjacent to its parent and its children, there are fewer entries per node in Table 21, relative to Table 17, for example.

As shown in FIG. 15, network 1500 has five parent branching nodes. As above, these parent branching nodes are depicted with dashed lines around them, and they include nodes 2 and 4 at level-2, and nodes 5 and 8 at level-3.

In similar fashion as described above for the networks of Examples A through D respectively, in a conventional software update process applied to Example E, the update originates at root node 1, and makes a separate trip to every other node in the network, beginning each trip at node 1. In terms of hops, and with reference to Table 21, this equals 34 hops. This sum is obtained by adding the rightmost column of the DSR, here Table 6.

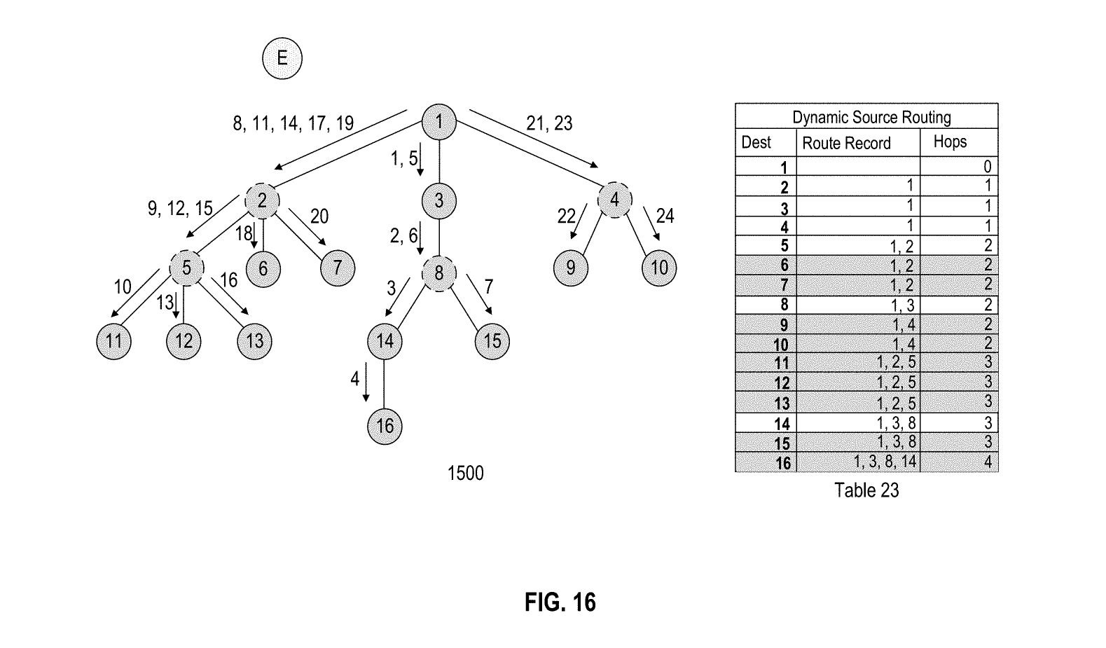

As may be seen in FIG. 16, network 1500 has nine leaf, or end, nodes. Each path to one of these leaf nodes is a separate branch of network 1500. Thus, improving upon the conventional software update process of 34 hops, as shown in FIG. 16, in embodiments implementing the first optimization, where no separate trip to each listed node is needed, but rather where each of the identified nine branches of network 1500, as described above, is traversed solely once, from root node to the end node of that branch, the number of hops to complete the transfer are shown in the nine shaded entries of DSR Table 23, whose rightmost columns sum to, from the bottom of the table upwards, (4+3+3+3+3+2+2+2+2) hops of N packets, resulting in 24*N traffic.

Thus, in such embodiments according to the first optimization, only entries for destination nodes 6, 7, 9, 10, 11, 12, 13, 15 and 16 of DSR Table 23, are used, being the nine leaf nodes of network 1500, and these entries may be extracted to form a routing table (not shown) for traversing network 1500, Example E, according to Optimization 1, in accordance with various embodiments. By using only these nine paths, all nodes in network 1500 are traversed. However, as further shown in FIG. 16, several nodes are traversed multiple times. Thus, as shown, node 2 is traversed five times, node 5 traversed three times, nodes 3 and 8 traversed twice each (they are on the same branch, node 8 the child node of node 3), and node 4 is also traversed twice.

Optimizing the traversal of network 1500 even further, in fully optimized embodiments, with reference to FIG. 17, nodes 2, 4, 5 and 8 are identified as parent branching nodes. Thus, the redundant hops to each of these four parent branching nodes may be consolidated, and when each of these four nodes are respectively first traversed, instructions are provided with the software update packets to pass the update packets onwards to each node's child branches. These include, at node 2, to pass the update on to each of nodes 5, 6 and 7. Moreover, the update, when passed to node 5, additionally is to include instructions to node 5 to further pass the update to its three child nodes, namely nodes 11, 12 and 13. Thus, node 2 receives a two layer “pass-on” instruction as regards node 5.

As a result of this second optimization, as shown in FIG. 17, overall network traffic is reduced to a net traffic of 15*N for N packets. As described above, in fully optimized embodiments, nodes 2, 4, 5 and 8 are provided with additional TX logic to accomplish the forwarding of their packets to each of their respective child nodes, or child branches, in the case of nodes 2 and 8.

Network 1500, Example E, thus shows that as the complexity of the network increases, the optimization achieved by exemplary processes also increases. In the case of network 1500, Example E, use of Optimization 1 provided a reduction of ˜30% of the hops, whereas use of Optimization 2 reduced by ˜65% the amount of hops for communicating the software update (e.g., FOTA) packages.

As illustrated above for each of the example networks of Examples A through E, an example DM agent may start with a DSR table, and then proceed to process it to generate an optimized routing table according to Optimization 1, which may then be further processed to generate an optimized routing table for Optimization 2, as described above. The DM agent then uses the optimized routing table to deploy a software update, such as, for example, a FOTA update. Next described, with reference to FIGS. 18 and 19, is an example process for generating an optimized routing table from a DSR table, in accordance with various embodiments. The example refers to the example mesh network 1200 of Case D, illustrated in FIGS. 12-14 and described above, for illustration. As noted above, in embodiments, either a routing table is maintained on gateway 120, or gateway 120 performs network discovery prior to determining an optimal set of traversals for the network. In either option, gateway 120 has data that indicates the shortest path from it to each node.

As shown in Table 24 of FIG. 18, the example process initially generates a list of destination nodes that need to be updated ordered by decreasing number of hops needed to reach them. Next, the process iterates over the table from top to bottom (e.g., by largest number of hops to smallest), updating it so as to obtain an improved routing table (IRT). In Table 24, the “Route Record” column lists the intermediate nodes that must be traversed to reach the destination node. Adding the rightmost column of Table 24 indicates that to traverse network 1200 using this set of traversals, a total of 20 hops is required. However, as noted above, the process operates to remove redundancy, and thus, in embodiments, if any intermediate node listed as part of a route record of a higher entry in Table 24 also appears in Table 24 as a destination node(in a lower entry of the table), the lower entry listing that intermediate node as its own destination node is removed from the table, as it will be reached as an intermediate node on the way to the destination node of the higher entry. Because a higher entry will always be a superset of a lower entry for one of the higher entry's intermediate node, the processing proceeds from top to bottom of the destination list.

Thus, with reference to Table 24, in a first iteration, after processing node 6 where it is noted that the intermediate nodes to node 6 include nodes 1, 2, 5, entries in Table 24 for these three entries, along with the entry for node 6, are removed, as shown in Table 25. Moreover, the entry for node 6 is added to the IRT shown in Table 26, which is a first iteration of the IRT.

In a second iteration node 10 of Table 25 is processed, and it, as well as entries for its intermediate nodes 4 and 10 are removed, to yield Table 27, a second iteration of the list of destination nodes. In addition, the entry for node 10 is added to the IRT, now shown at Table 28, its second iteration.

Tables for the next two iterations are shown on FIG. 19. With reference to FIG. 19, Table 27 from FIG. 18 is shown at the top left of FIG. 19. Table 27 was the result of the second iteration of the destination list, and is now the input to the third iteration. In the third iteration the entry for node 11, now the topmost entry remaining in the destination list, is analyzed. It is noted that node 11 has as intermediate nodes 1, 4 and 8, and that an entry for node 8 remains in Table 27. Thus, the entries for both nodes 11 and 8 are removed from the table, leaving Table 29, the third iteration of the destination list. Moreover, the entry for node 11 is added to the IRT, whose third iteration is shown in Table 30.

Continuing with reference to FIG. 19, a fourth and final iteration of the destination list is performed, by operating on Table 29, the current version of the destination list. In this fourth iteration the entry for node 7 in Table 29 is processed, in which it is noted that it has node 3 as an intermediate node, and that node 3 has an entry in Table 29. Thus, as above, the entries for both nodes 7 and 3 are removed from Table 29, leaving it empty. Similarly, the entry for node 7 (a superset of node 3) is added to the IRT, which is shown, in its fourth iteration, in Table 31. Because there are no more entries of the original destination list to process, processing is done, and Table 31 may be used as the set of traversals for the network, here network 1200, Example D. As shown in Table 31, there are a total of 11 hops needed to traverse the network. The total cost, using IRT to reach all the nodes is 11 hops compared to 20 hops using the traditional process, which represents a cost reduction of 45%.

Continuing with reference to FIG. 19, Table 32 depicts a further optimization of the IRT of Table 31, which may be used, in embodiments, when the additional TX hardware is provided at intermediate nodes, as described above. The second optimized IRT of Table 32 thus takes into account caching at intermediate nodes that helps to reduce the overall number of hops needed to traverse the network. Here, as described above with reference to FIG. 14, because node 14 is a parent branching node, once it is traversed in a path to node 11, as per the first entry in Table 3, there is no need to start again at node 1 and traverse a path to node 4. Thus, the number of hops it takes to reach Node 10 in this second optimization is 2, as shown at entry 1910, as node 4 is instructed to cache the packet and forward it directly to node 9. This reduces the hop count by 1, now to 10 hops, as shown at 1920.

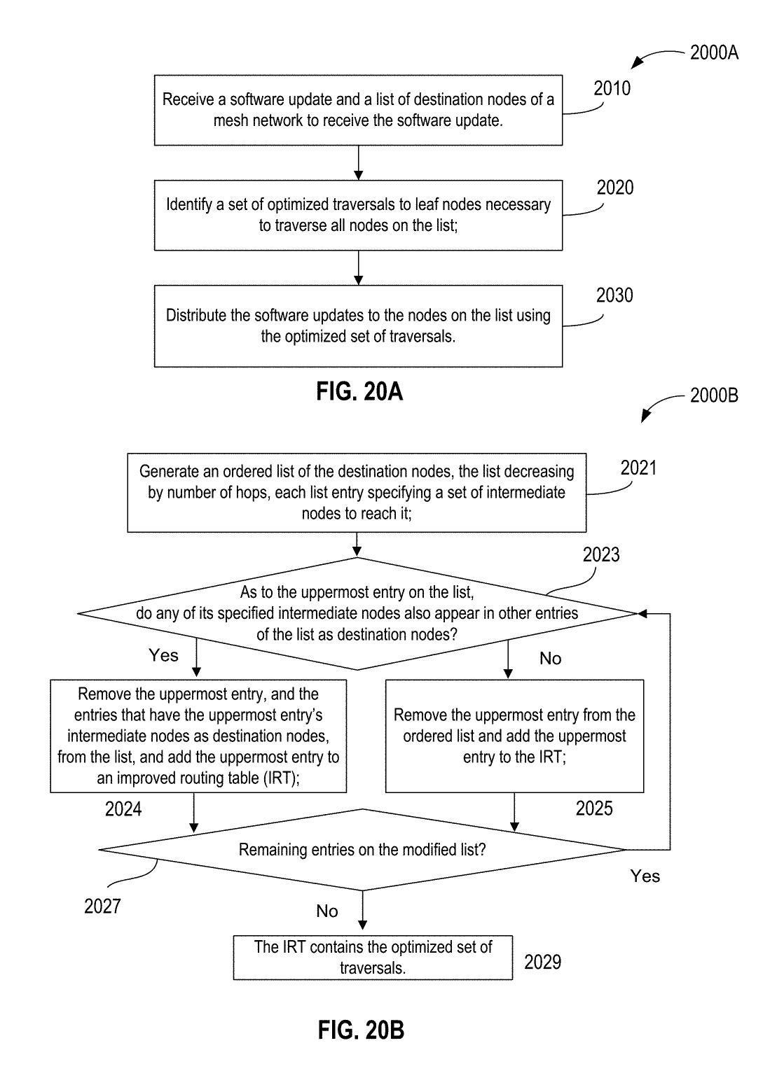

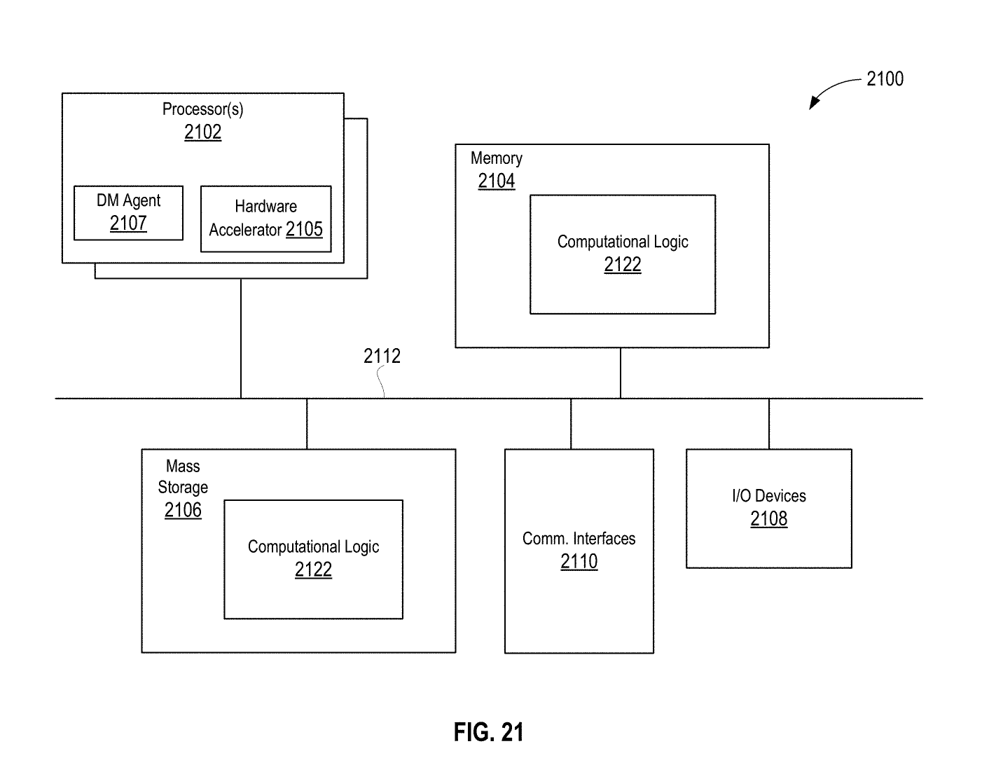

Referring now to FIG. 20A, an overview of the operational flow of a process for receiving a software update and a list of nodes, identifying a set of optimized traversals to cover the listed nodes, and distributing the software update, in accordance with various embodiments, is presented. Process 2000A may be performed by a CPU or processor, such as processor 2102 of FIG. 21, or a DM agent 125 of a gateway 120, in conjunction with a LPWAN interface 127, all as shown in FIG. 1, in accordance with various embodiments. Process 2000A may include blocks 2010 through 2030. In alternate embodiments, process 2000A may have more or less operations, and some of the operations may be performed in different order.

With reference to FIG. 20A, process 2000A begins at block 2010, where a software update and a list of destination nodes of a mesh network to receive the software update is received by e.g., a CPU or a DM. For example, the network may be a tree-mesh network of sensor nodes, and the software update may be a FOTA update for some of the sensor nodes. In embodiments, the destination nodes include both intermediate nodes and leaf, or end, nodes.

From block 2010, process 2000A proceeds to block 2020, where a set of optimized traversals to the leaf nodes necessary to traverse all of the destination nodes on the list is identified, e.g., the CPU or DM.

From block 2020, process 2000A moves to block 2030, where the software updates are distributed to the nodes on the list using the optimized set of traversals, by e.g., the CPU or DM.

FIG. 20B illustrates a related process, process 2000B, to that shown in FIG. 20A, described above. Process 2000B provides a more detailed version of block 2020 of process 2000A of FIG. 20A. Process 2000B may be performed e.g., by a CPU or processor, such as processor 2102 of FIG. 21, or a DM agent 125 of a gateway 120, in conjunction with a LPWAN interface 127, all as shown in FIG. 1, in accordance with various embodiments. Process 2000B may include blocks 2021 through 2029. In alternate embodiments, process 2000B may have more or less operations, and some of the operations may be performed in different order.

With reference to FIG. 20B, process 2000B begins at block 2021, where an ordered list of destination nodes, the list decreasing by number of hops, and each list entry specifying a set of intermediate nodes to reach it, are generated by e.g., a CPU or DM. Thus, the uppermost entry on the list has the largest number of hops at any time. For example, the list of destination nodes may be that received in block 2010 of FIG. 20A. In embodiments, the destination nodes include both intermediate nodes and leaf, or end, nodes. For example, the list of destination nodes may be that of Table 24 of FIG. 18, described above.

From block 2021, process 2000B proceeds to query block 2023, where for the uppermost entry on the list, whether any of its specified intermediate nodes also appear in other, lower, entries of the list, as destination nodes, is determined e.g., by the CPU or DM agent.

If “Yes” at query block 2023, then process 2000B moves to block 2024, where the uppermost entry, and the entries that have the uppermost entry's intermediate nodes as destination nodes, are all removed from the list, and the uppermost entry added to an improved routing table (IRT), e.g., by the CPU or DM agent.

However, if “No” at query block 2023, then process 2000B moves to block 2025, where the uppermost entry is removed from the list, and added to the IRT. In both the case of block 2024 and block 2025, removal of the uppermost entry from the list causes a new entry to be the uppermost list, as was the case, for example, in Table 25 of FIG. 18, when the first entry of Table 24, also shown in FIG. 18, was removed, e.g., by the CPU or DM.

From blocks 2024 and 2025, as the case may be, process 2000B proceeds to query block 2027, where whether there are remaining entries on the list, is determined e.g., by the CPU or DM agent. If “Yes” at query block 2027, then process 2000B moves back to block 2023, where the then current uppermost entry is processed, as described above. However, if “No” at query block 2027, then there are no further entries on the list of destination nodes generated at block 2021, and process 2000B moves to block 2029, where the IRT now contains the optimized set of traversals.

Referring now to FIG. 21, wherein a block diagram of a computer device suitable for practicing the present disclosure, in accordance with various embodiments, is illustrated. As shown, computer device 2100 may include one or more processors 2102, and system memory 2104. Each processor 2102 may include one or more processor cores, and hardware accelerator 2105. An example of hardware accelerator 2107 may include, but is not limited to, programmed field programmable gate arrays (FPGA). In some embodiments, computing device 2100 may be used as a gateway, such as GW 120 of FIG. 1. In other embodiments, computing device 2100 may be used as DM agent 125 of gateway 120 of FIG. 1.

Computer device 2100 may also include system memory 2104. In embodiments, system memory 2104 may include any known volatile or non-volatile memory. Additionally, computer device 2100 may include mass storage device(s) 2106, input/output device interfaces 2108 (to interface with various input/output devices, such as, mouse, cursor control, display device (including touch sensitive screen), and so forth) and communication interfaces 2110 (such as network interface cards, modems and so forth). In embodiments, communication interfaces 2110 may interface with a LPWAN 127 shown in FIG. 1, as part of GW 120. In embodiments, communication interfaces 2110 may support wired or wireless communication, including near field communication. The elements may be coupled to each other via system bus 2112, which may represent one or more buses. In the case of multiple buses, they may be bridged by one or more bus bridges (not shown).

In embodiments, system memory 2104 and mass storage device(s) 2117 may be employed to store a working copy and a permanent copy of the executable code of the programming instructions of an operating system, one or more applications, and/or various software implemented operations associated with gateway 120, DM agent 125, of FIG. 1, collectively referred to as computational logic 2122. The programming instructions implementing computational logic 2122 may comprise assembler instructions supported by processor(s) 2102 or high-level languages, such as, for example, C, that can be compiled into such instructions. In embodiments, some of computing logic may be implemented in hardware accelerator 2105. In embodiments, part of computational logic 2122, e.g., a portion of the computational logic 2122 associated with the runtime environment of the compiler may be implemented in hardware accelerator 2105.

The permanent copy of the executable code of the programming instructions or the bit streams for configuring hardware accelerator 2105 may be placed into permanent mass storage device(s) 2106 and/or hardware accelerator 2105 in the factory, or in the field, through, for example, a distribution medium (not shown), such as a compact disc (CD), or through communication interfaces 2110 (from a distribution server (not shown)).

The number, capability and/or capacity of these elements 2102-2122 may vary, depending on the intended use of example computer device 2100, e.g., whether example computer device 2100 is a desktop computer, a server, a set-top box, a networking device, a switch, a gateway, and so forth. The constitutions of these elements 2110-2122 are otherwise known, and accordingly will not be further described.

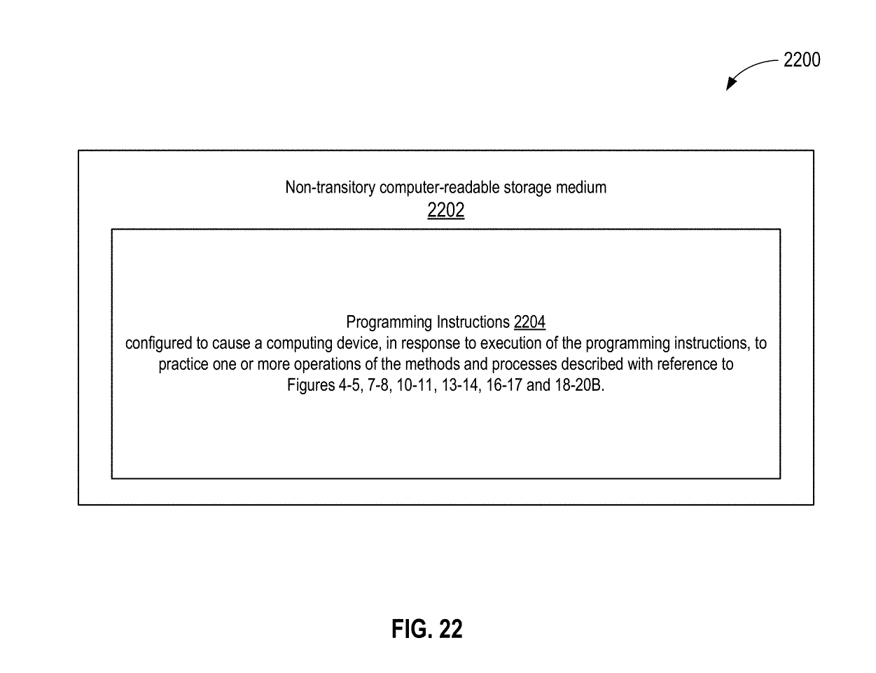

Furthermore, the present disclosure may take the form of a computer program product or data to create the computer program, with the computer program or data embodied in any tangible or non-transitory medium of expression having the computer-usable program code (or data to create the computer program) embodied in the medium. FIG. 22 illustrates an example computer-readable non-transitory storage medium that may be suitable for use to store instructions (or data that creates the instructions) that cause an apparatus, in response to execution of the instructions by the apparatus, to practice selected aspects of the present disclosure, including, for example, to implement all (or portion of) software implementations of gateway 120, DM agent 125 of FIG. 1, and/or practice (aspects of) processes 2000A of FIG. 20A and 2000B of FIG. 20B, earlier described, in accordance with various embodiments. As shown, non-transitory computer-readable storage medium 2202 may include a number of programming instructions 2204 (or data to create the programming instructions). Programming instructions 2204 may be configured to enable a device, e.g., device 2100, in response to execution of the programming instructions, to perform, e.g., various programming operations associated with operating system functions, one or more applications, and/or aspects of the present disclosure. For example, executable code of programming instructions (or bit streams) 2204 may be configured to enable a device, e.g., computer device 2100, in response to execution of the executable code/programming instructions (or operation of an encoded hardware accelerator 2105), to perform (aspects of) processes performed by gateway 120 or DM agent 125, of FIG. 1, and/or practice (aspects of) processes 2000A of FIG. 20A and 2000B of FIG. 20B.

In alternate embodiments, programming instructions 2204 (or data to create the instructions) may be disposed on multiple computer-readable non-transitory storage media 2202 instead. In alternate embodiments, programming instructions 2204 (or data to create the instructions) may be disposed on computer-readable transitory storage media 2202, such as, signals. Any combination of one or more computer usable or computer readable medium(s) may be utilized. The computer-usable or computer-readable medium may be, for example but not limited to, one or more electronic, magnetic, optical, electromagnetic, infrared, or semiconductor systems, apparatuses, devices, or propagation media. More specific examples (a non-exhaustive list) of a computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program (or data to create the program) is printed, as the program (or data to create the program) can be electronically captured, via, for instance, optical scanning of the paper or other medium, then compiled, interpreted, or otherwise processed in a suitable manner, if necessary, and then stored in a computer memory (with or without having been staged in or more intermediate storage media). In the context of this document, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (or data to create the program code) embodied therewith, either in baseband or as part of a carrier wave. The computer usable program code (or data to create the program) may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (or data to create the program code) as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code (or data to create the program code) may be stored in multiple parts, which are individually compressed, encrypted, and stored on separate computing devices, wherein the parts when decrypted, decompressed, and combined form a set of executable instructions that implement the program code (the data to create the program code(such as that described herein. In another example, the Program code (or data to create the program code) may be stored in a state in which they may be read by a computer, but require addition of a library (e.g., a dynamic link library), a software development kit (SDK), an application programming interface (API), etc. in order to execute the instructions on a particular computing device or other device. In another example, the Program code (or data to create the program code) may need to be configured (e.g., settings stored, data input, network addresses recorded, etc.) before the program code (or data to create the program code) can be executed/used in whole or in part. Thus, the disclosed Program code (or data to create the program code) are intended to encompass such machine readable instructions and/or program(s) (or data to create such machine readable instruction and/or programs) regardless of the particular format or state of the machine readable instructions and/or program(s) when stored or otherwise at rest or in transit.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Referring back to FIG. 21, for one embodiment, at least one of processors 2102 may be packaged together with a computer-readable storage medium having some or all of computing logic 2122 (in lieu of storing in system memory 2104 and/or mass storage device 2106) configured to practice all or selected ones of the operations earlier described with reference to FIGS. 1-20. For one embodiment, at least one of processors 2102 may be packaged together with a computer-readable storage medium having some or all of computing logic 2122 to form a System in Package (SiP). For one embodiment, at least one of processors 2102 may be integrated on the same die with a computer-readable storage medium having some or all of computing logic 2122. For one embodiment, at least one of processors 2102 may be packaged together with a computer-readable storage medium having some or all of computing logic 2122 to form a System on Chip (SoC). For at least one embodiment, the SoC may be utilized in, e.g., but not limited to, a hybrid computing tablet/laptop.

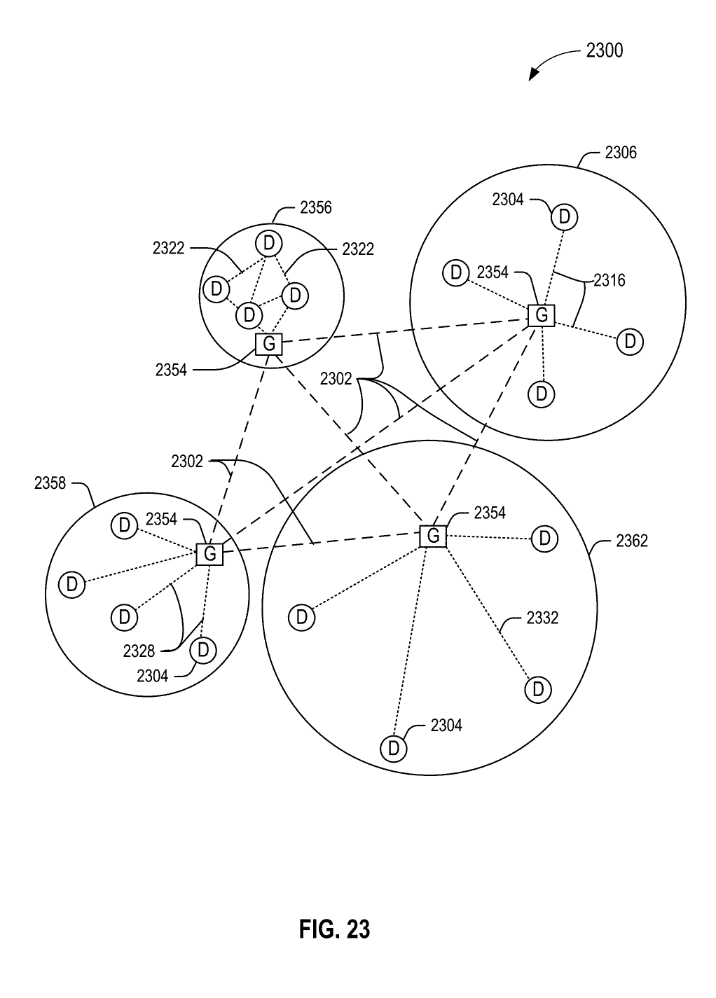

FIG. 23 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

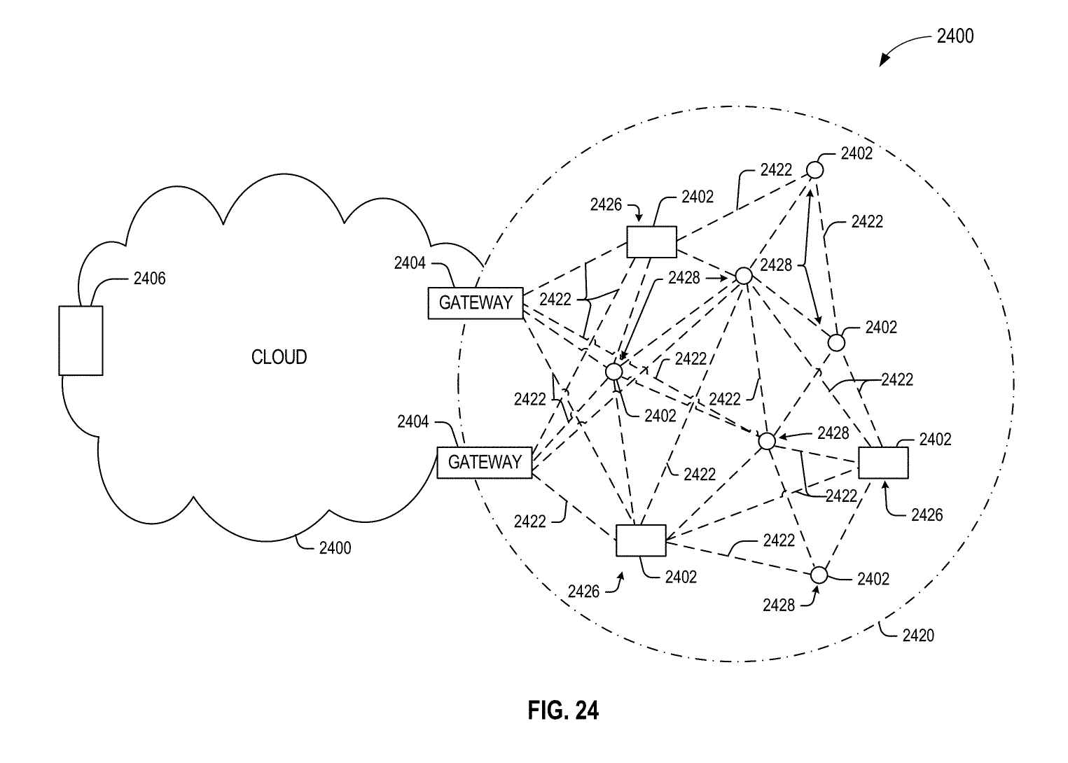

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 23 and 24, present a number of new challenges in a heterogeneous network of connectivity comprising a combination of wired and wireless technologies.

FIG. 23 specifically provides a simplified drawing of a domain topology that may be used for a number of internet-of-things (IoT) networks comprising IoT devices 2304, with the IoT networks 2356, 2358, 2360, 2362, coupled through backbone links 2302 to respective gateways 2354. For example, a number of IoT devices 2304 may communicate with a gateway 2354, and with each other through the gateway 2354. To simplify the drawing, not every IoT device 2304, or communications link (e.g., link 2316, 2322, 2328, or 2332) is labeled. The backbone links 2302 may include any number of wired or wireless technologies, including optical networks, and may be part of a local area network (LAN), a wide area network (WAN), or the Internet. Additionally, such communication links facilitate optical signal paths among both IoT devices 2304 and gateways 2354, including the use of MUXing/deMUXing components that facilitate interconnection of the various devices.

The network topology may include any number of types of IoT networks, such as a mesh network provided with the network 2356 using Bluetooth low energy (BLE) links 2322. Other types of IoT networks that may be present include a wireless local area network (WLAN) network 2358 used to communicate with IoT devices 2304 through IEEE 802.11 (Wi-Fi®) links 2328, a cellular network 2360 used to communicate with IoT devices 2304 through an LTE/LTE-A (4G) or 5G cellular network, and a low-power wide area (LPWA) network 2362, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 2304, such as over the backbone links 2302, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 2356, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 2358, for instance, may use systems that perform standards conversion to provide multi-standard connectivity, enabling IoT devices 2304 using different protocols to communicate. Further systems may provide seamless interconnectivity across a multi-standard infrastructure comprising visible Internet resources and hidden Internet resources.

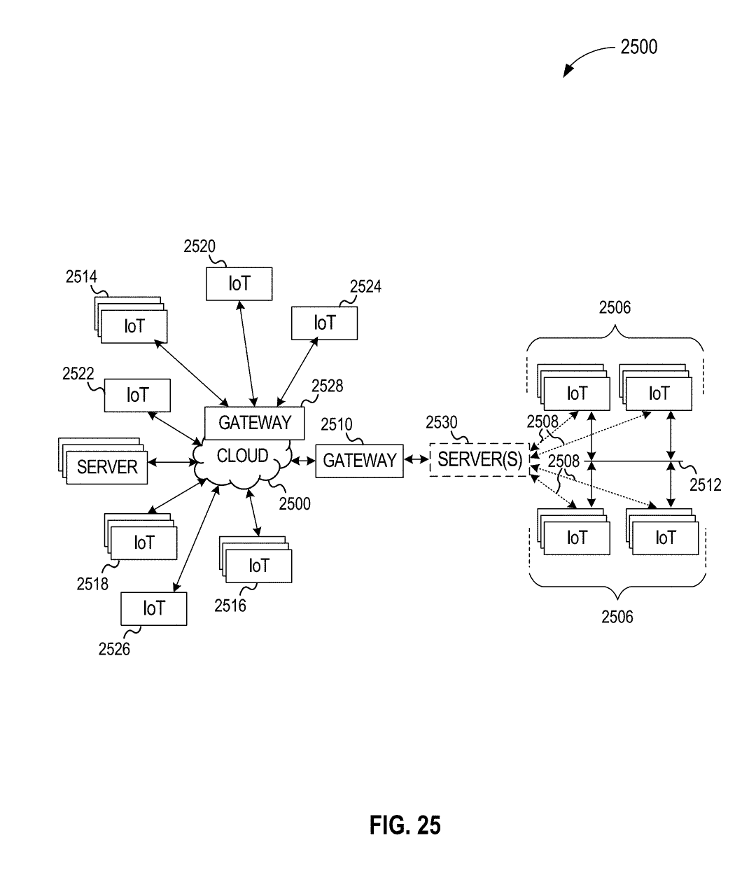

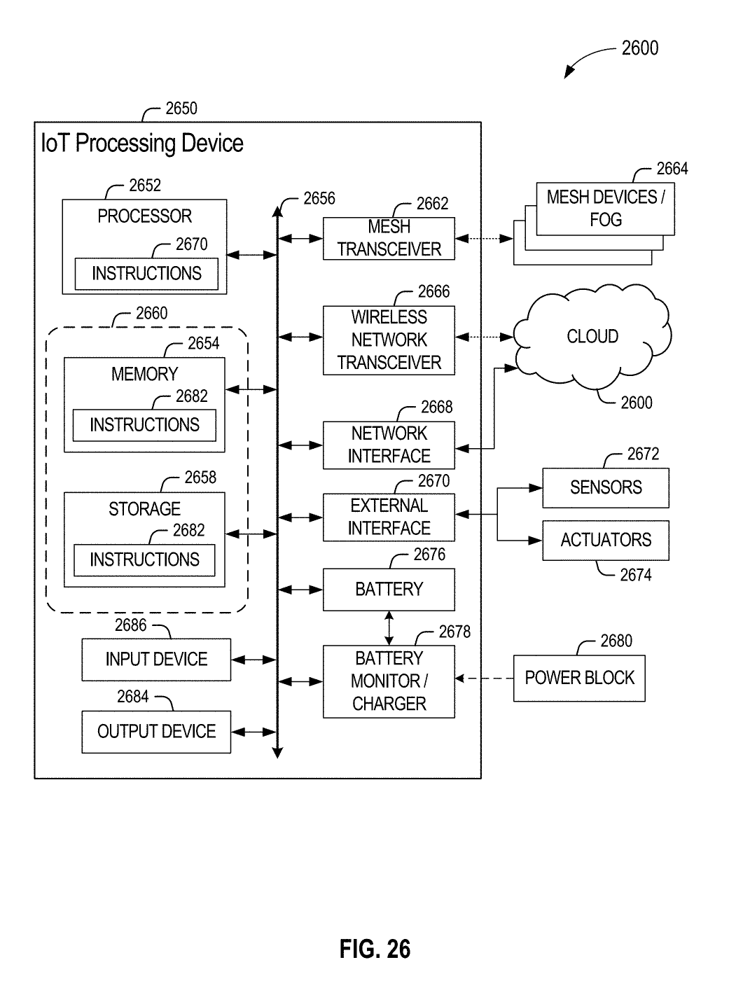

Communications in the cellular network 2360, for instance, may be enhanced by systems that offload data, extend communications to more remote devices, or both. The LPWA network 2362 may include systems that perform non-Internet protocol (IP) to IP interconnections, addressing, and routing. Further, each of the IoT devices 2304 may include the appropriate transceiver for wide area communications with that device. Further, each IoT device 2304 may include other transceivers for communications using additional protocols and frequencies. This is discussed further with respect to the communication environment and hardware of an IoT processing device depicted in FIGS. 25 and 26.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 24 below.

FIG. 24 illustrates a cloud computing network in communication with a mesh network of IoT devices (devices 2402) operating as a fog device at the edge of the cloud computing network. The mesh network of IoT devices may be termed a fog 2420, operating at the edge of the cloud 2400. To simplify the diagram, not every IoT device 2402 is labeled.

The fog 2420 may be considered to be a massively interconnected network wherein a number of IoT devices 2402 are in communications with each other, for example, by radio links 2422. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 2402 are shown in this example, gateways 2404, data aggregators 2426, and sensors 2428, although any combinations of IoT devices 2402 and functionality may be used. The gateways 2404 may be edge devices that provide communications between the cloud 2400 and the fog 2420, and may also provide the backend process function for data obtained from sensors 2428, such as motion data, flow data, temperature data, and the like. The data aggregators 2426 may collect data from any number of the sensors 2428, and perform the back end processing function for the analysis. The results, raw data, or both may be passed along to the cloud 2400 through the gateways 2404. The sensors 2428 may be full IoT devices 2402, for example, capable of both collecting data and processing the data. In some cases, the sensors 2428 may be more limited in functionality, for example, collecting the data and allowing the data aggregators 2426 or gateways 2404 to process the data.

Communications from any IoT device 2402 may be passed along a convenient path (e.g., a most convenient path) between any of the IoT devices 2402 to reach the gateways 2404. In these networks, the number of interconnections provide substantial redundancy, allowing communications to be maintained, even with the loss of a number of IoT devices 2402. Further, the use of a mesh network may allow IoT devices 2402 that are very low power or located at a distance from infrastructure to be used, as the range to connect to another IoT device 2402 may be much less than the range to connect to the gateways 2404.

The fog 2420 provided from these IoT devices 2402 may be presented to devices in the cloud 2400, such as a server 2406, as a single device located at the edge of the cloud 2400, e.g., a fog device. In this example, the alerts coming from the fog device may be sent without being identified as coming from a specific IoT device 2402 within the fog 2420. In this fashion, the fog 2420 may be considered a distributed platform that provides computing and storage resources to perform processing or data-intensive tasks such as data analytics, data aggregation, and machine-learning, among others.

In some examples, the IoT devices 2402 may be configured using an imperative programming style, e.g., with each IoT device 2402 having a specific function and communication partners. However, the IoT devices 2402 forming the fog device may be configured in a declarative programming style, allowing the IoT devices 2402 to reconfigure their operations and communications, such as to determine needed resources in response to conditions, queries, and device failures. As an example, a query from a user located at a server 2406 about the operations of a subset of equipment monitored by the IoT devices 2402 may result in the fog 2420 device selecting the IoT devices 2402, such as particular sensors 2428, needed to answer the query. The data from these sensors 2428 may then be aggregated and analyzed by any combination of the sensors 2428, data aggregators 2426, or gateways 2404, before being sent on by the fog 2420 device to the server 2406 to answer the query. In this example, IoT devices 2402 in the fog 2420 may select the sensors 2428 used based on the query, such as adding data from flow sensors or temperature sensors. Further, if some of the IoT devices 2402 are not operational, other IoT devices 2402 in the fog 2420 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 25 illustrates a drawing of a cloud computing network, or cloud 2500, in communication with a number of Internet of Things (IoT) devices. The cloud 2500 may represent the Internet, or may be a local area network (LAN), or a wide area network (WAN), such as a proprietary network for a company. The IoT devices may include any number of different types of devices, grouped in various combinations. For example, a traffic control group 2506 may include IoT devices along streets in a city. These IoT devices may include stoplights, traffic flow monitors, cameras, weather sensors, and the like. The traffic control group 2506, or other subgroups, may be in communication with the cloud 2500 through wired or wireless links 2508, such as LPWA links, optical links, and the like. Further, a wired or wireless sub-network 2512 may allow the IoT devices to communicate with each other, such as through a local area network, a wireless local area network, and the like. The IoT devices may use another device, such as a gateway 2510 or 2528 to communicate with remote locations such as the cloud 2500; the IoT devices may also use one or more servers 2530 to facilitate communication with the cloud 2500 or with the gateway 2510. For example, the one or more servers 2530 may operate as an intermediate network node to support a local edge cloud or fog implementation among a local area network. Further, the gateway 2528 that is depicted may operate in a cloud-to-gateway-to-many edge devices configuration, such as with the various IoT devices 2514, 2520, 2524 being constrained or dynamic to an assignment and use of resources in the cloud 2500.

Other example groups of IoT devices may include remote weather stations 2514, local information terminals 2516, alarm systems 2518, automated teller machines 2520, alarm panels 2522, or moving vehicles, such as emergency vehicles 2524 or other vehicles 2526, among many others. Each of these IoT devices may be in communication with other IoT devices, with servers 2504, with another IoT fog device or system (not shown, but depicted in FIG. 24), or a combination therein. The groups of IoT devices may be deployed in various residential, commercial, and industrial settings (including in both private or public environments).

As can be seen from FIG. 25, a large number of IoT devices may be communicating through the cloud 2500. This may allow different IoT devices to request or provide information to other devices autonomously. For example, a group of IoT devices (e.g., the traffic control group 2506) may request a current weather forecast from a group of remote weather stations 2514, which may provide the forecast without human intervention. Further, an emergency vehicle 2524 may be alerted by an automated teller machine 2520 that a burglary is in progress. As the emergency vehicle 2524 proceeds towards the automated teller machine 2520, it may access the traffic control group 2506 to request clearance to the location, for example, by lights turning red to block cross traffic at an intersection in sufficient time for the emergency vehicle 2524 to have unimpeded access to the intersection.

Clusters of IoT devices, such as the remote weather stations 2514 or the traffic control group 2506, may be equipped to communicate with other IoT devices as well as with the cloud 2500. This may allow the IoT devices to form an ad-hoc network between the devices, allowing them to function as a single device, which may be termed a fog device or system (e.g., as described above with reference to FIG. 24).

FIG. 26 is a block diagram of an example of components that may be present in an IoT device 2650 for implementing the techniques described herein. The IoT device 2650 may include any combinations of the components shown in the example or referenced in the disclosure above. The components may be implemented as ICs, portions thereof, discrete electronic devices, or other modules, logic, hardware, software, firmware, or a combination thereof adapted in the IoT device 2650, or as components otherwise incorporated within a chassis of a larger system. Additionally, the block diagram of FIG. 26 is intended to depict a high-level view of components of the IoT device 2650. However, some of the components shown may be omitted, additional components may be present, and different arrangement of the components shown may occur in other implementations.

The IoT device 2650 may include a processor 2652, which may be a microprocessor, a multi-core processor, a multithreaded processor, an ultra-low voltage processor, an embedded processor, or other known processing element. The processor 2652 may be a part of a system on a chip (SoC) in which the processor 2652 and other components are formed into a single integrated circuit, or a single package, such as the Edison™ or Galileo™ SoC boards from Intel. As an example, the processor 2652 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, California, a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 2652 may communicate with a system memory 2654 over an interconnect 2656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2658 may also couple to the processor 2652 via the interconnect 2656. In an example the storage 2658 may be implemented via a solid state disk drive (SSDD). Other devices that may be used for the storage 2658 include flash memory cards, such as SD cards, microSD cards, xD picture cards, and the like, and USB flash drives. In low power implementations, the storage 2658 may be on-die memory or registers associated with the processor 2652. However, in some examples, the storage 2658 may be implemented using a micro hard disk drive (HDD). Further, any number of new technologies may be used for the storage 2658 in addition to, or instead of, the technologies described, such resistance change memories, phase change memories, holographic memories, or chemical memories, among others.

The components may communicate over the interconnect 2656. The interconnect 2656 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2656 may be a proprietary bus, for example, used in a SoC based system. Other bus systems may be included, such as an I2C interface, an SPI interface, point to point interfaces, and a power bus, among others.

The interconnect 2656 may couple the processor 2652 to a mesh transceiver 2662, for communications with other mesh devices 2664. The mesh transceiver 2662 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 2664. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 2662 may communicate using multiple standards or radios for communications at different range. For example, the IoT device 2650 may communicate with close devices, e.g., within about 10 meters, using a local transceiver based on BLE, or another low power radio, to save power. More distant mesh devices 2664, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 2666 may be included to communicate with devices or services in the cloud 2600 via local or wide area network protocols. The wireless network transceiver 2666 may be a LPWA transceiver that follows the IEEE 802.15.4, or IEEE 802.15.4g standards, among others. The IoT device 2650 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 2662 and wireless network transceiver 2666, as described herein. For example, the radio transceivers 2662 and 2666 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 2662 and 2666 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 2666, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 2668 may be included to provide a wired communication to the cloud 2600 or to other devices, such as the mesh devices 2664. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional MC 2668 may be included to allow connect to a second network, for example, a NIC 2668 providing communications to the cloud over Ethernet, and a second NIC 2668 providing communications to other devices over another type of network.

The interconnect 2656 may couple the processor 2652 to an external interface 2670 that is used to connect external devices or subsystems. The external devices may include sensors 2672, such as accelerometers, level sensors, flow sensors, optical light sensors, camera sensors, temperature sensors, a global positioning system (GPS) sensors, pressure sensors, barometric pressure sensors, and the like. The external interface 2670 further may be used to connect the IoT device 2650 to actuators 2674, such as power switches, valve actuators, an audible sound generator, a visual warning device, and the like.

In some optional examples, various input/output (I/O) devices may be present within, or connected to, the IoT device 2650. For example, a display or other output device 2684 may be included to show information, such as sensor readings or actuator position. An input device 2686, such as a touch screen or keypad may be included to accept input. An output device 2684 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 2650.

A battery 2676 may power the IoT device 2650, although in examples in which the IoT device 2650 is mounted in a fixed location, it may have a power supply coupled to an electrical grid. The battery 2676 may be a lithium ion battery, or a metal-air battery, such as a zinc-air battery, an aluminum-air battery, a lithium-air battery, and the like.

A battery monitor/charger 2678 may be included in the IoT device 2650 to track the state of charge (SoCh) of the battery 2676. The battery monitor/charger 2678 may be used to monitor other parameters of the battery 2676 to provide failure predictions, such as the state of health (SoH) and the state of function (SoF) of the battery 2676. The battery monitor/charger 2678 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2678 may communicate the information on the battery 2676 to the processor 2652 over the interconnect 2656. The battery monitor / charger 2678 may also include an analog-to-digital (ADC) convertor that allows the processor 2652 to directly monitor the voltage of the battery 2676 or the current flow from the battery 2676. The battery parameters may be used to determine actions that the IoT device 2650 may perform, such as transmission frequency, mesh network operation, sensing frequency, and the like.

A power block 2680, or other power supply coupled to a grid, may be coupled with the battery monitor/charger 2678 to charge the battery 2676. In some examples, the power block 2680 may be replaced with a wireless power receiver to obtain the power wirelessly, for example, through a loop antenna in the IoT device 2650. A wireless battery charging circuit, such as an LTC4020 chip from Linear Technologies of Milpitas, Calif., among others, may be included in the battery monitor/charger 2678. The specific charging circuits chosen depend on the size of the battery 2676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2658 may include instructions 2682 in the form of software, firmware, or hardware commands to implement the techniques described herein. Although such instructions 2682 are shown as code blocks included in the memory 2654 and the storage 2658, it may be understood that any of the code blocks may be replaced with hardwired circuits, for example, built into an application specific integrated circuit (ASIC).

In an example, the instructions 2682 provided via the memory 2654, the storage 2658, or the processor 2652 may be embodied as a non-transitory, machine readable medium 2660 including code to direct the processor 2652 to perform electronic operations in the IoT device 2650. The processor 2652 may access the non-transitory, machine readable medium 2660 over the interconnect 2656. For instance, the non-transitory, machine readable medium 2660 may be embodied by devices described for the storage 2658 of FIG. 25 or may include specific storage units such as optical disks, flash drives, or any number of other hardware devices. The non-transitory, machine readable medium 2660 may include instructions to direct the processor 2652 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Illustrative examples of the technologies disclosed herein are provided below. An embodiment of the technologies may include any one or more, and any combination of, the examples described below.

### EXAMPLES

Example 1 includes an apparatus for selectively delivering software updates to nodes in a network, comprising: a receiver to receive a software update and a list of nodes of the network scheduled to receive the software update; and a device management agent (DMA), to: identify a set of traversals to leaf nodes of the list of nodes necessary to traverse all nodes on the list, and distribute the software updates to the nodes on the list using the set of traversals.

Example 2 is the apparatus of example 1, and/or other examples herein, wherein the network is a sensor mesh network, and wherein the software update includes a firmware update for one or more sensors disposed at each network node on the list.

Example 3 is the apparatus of example 1, and/or other examples herein, wherein the software update is a firmware update, and wherein the DMA is further to signal all of the nodes on the list, prior to distributing the update, to transition the nodes on the list into a firmware over the air (FOTA) progress state.

Example 4 is the apparatus of example 1, and/or other examples herein, wherein the nodes on the list include both intermediate nodes with descendant nodes and leaf nodes without descendant nodes, and the DMA is further to distribute the software update to the leaf nodes through the intermediate nodes, including provision of instruction to an intermediate node to distribute the software update to its descendant nodes.

Example 5 is the apparatus of example 4, and/or other examples herein, wherein the DMA is further to traverse an intermediate node that branches into two or more descendant nodes just once.

Example 6 is the apparatus of example 4, and/or other examples herein, wherein the DMA is further to instruct intermediate nodes on the list to cache the update, and instruct intermediate nodes that are not on the list, but that have descendant nodes that are on the list, to forward the update.

Example 7 is the apparatus of example 1, and/or other examples herein, wherein the nodes on the list are a subset of all of the nodes in the network.

Example 8 is the apparatus of example 1, and/or other examples herein, wherein the nodes in the network have a tree-mesh toplogy.

Example 9 is the apparatus of example 8, and/or other examples herein, wherein the nodes on the list include both leaf nodes and intermediate nodes, on one or more branches of the tree-mesh topology.

Example 10 is the apparatus of example 1, and/or other examples herein, wherein the DMA is further to perform network discovery prior to identification of the set of traversals to the leaf nodes of the list of nodes necessary to traverse all nodes on the list.

Example 11 is the apparatus of example 1, and/or other examples herein, wherein the DMA is further to, following distribution of the update, signal all of the nodes in the network, with a FOTA-complete-verify transmission.

Example 12 is the apparatus of example 1, and/or other examples herein, wherein the network is a mesh network, and the apparatus is a gateway of the mesh network, the gateway having the receiver and the DMA.

Example 13 is one or more non-transitory computer-readable storage media comprising a set of instructions, which, when executed on a network gateway (NG) coupled to a network of nodes, cause the NG to: receive a firmware (FW) update and a list of destination nodes (DNs) that are to receive the FW update; identify a set of traversals to leaf DNs that traverses all of the DNs, wherein if there are two possible traversals to a DN, the traversal with the fewest hops is included in the set; and distribute the update to the destination nodes according to the set of traversals.

Example 14 is the one or more non-transitory computer-readable storage media of example 13, and/or other examples herein, wherein the network is a sensor network having either a tree-mesh toplogy or a mesh topology, and wherein the FW update includes an update for one or more sensors disposed at each DN.

Example 15 is the one or more non-transitory computer-readable storage media of example 13, and/or other examples herein, wherein the network includes at least one intermediate node that branches into two or more branches (parent branching node) that include DNs and wherein the set of traversals is such that the at least one parent branching node is traversed just once.

Example 16 is the one or more non-transitory computer-readable storage media of example 15, and/or other examples herein, further comprising instructions, that when executed, cause the NG to instruct at least one the parent branching node to distribute the update to its descendant nodes.

Example 17 is the one or more non-transitory computer-readable storage media of example 13, and/or other examples herein, further comprising instructions that, when executed, further cause the NG to signal all of the DNs, prior to distributing the update, to transition into a firmware over the air (FOTA) progress state.

Example 18 is the one or more non-transitory computer-readable storage media of example 13, and/or other examples herein, further comprising instructions that, when executed, further cause the NG to perform network discovery prior to identification of the set of traversals to leaf nodes to traverse all DNs on the list.

Example 19 is the one or more non-transitory computer-readable storage media of example 13, and/or other examples herein, further comprising instructions that, when executed, further cause the NG to instruct intermediate nodes on the list to cache the update, and intermediate nodes not on the list, but on a traversal path to another node that is on the list, to forward the update.

Example 20 is the one or more non-transitory computer-readable storage media of example 13, and/or other examples herein, further comprising instructions that, when executed, further cause the NG, following distribution of the update, to signal all of the nodes in the network with a FOTA-complete-verify transmission.

Example 21 is a method of determining a set of traversals to leaf nodes in a network, comprising: receiving a FW update and a list of network nodes to be updated; identifying intermediate nodes, leaf nodes and parent branching nodes on the list; and distributing the update to all nodes on the list using a set of traversals to the leaf nodes on the list, wherein the set of traversals is such that a unique branch descending from a parent branching node is traversed just once.

Example 22 is the method of example 21, and/or other examples herein, further comprising, for the nodes on the list, calculating a route and a number of hops to the node.

Example 23 is the method of example 22, and/or other examples herein, further comprising identifying the routes with the greatest number of hops (GNH routes), and deleting routes that cover a set of nodes included in a GNH route.

Example 24 is the method of example 23, and/or other examples herein, further comprising identifying parent branching nodes on the GNH routes, and combining GNH routes that share an identical path to the parent branching node so as to only traverse a path to the parent branching node once.

Example 25 is the method of example 21, and/or other examples herein, further comprising: signaling all of the nodes on the list, prior to distributing the FW update, to transition into a firmware over the air (FOTA) progress state; and following distribution of the update, signaling all of the nodes in the network with a FOTA-complete-verify transmission.

Example 26 is an apparatus for computing, comprising: means for receiving a software update and a list of nodes of the network scheduled to receive the software update; means for identifying a set of traversals to leaf nodes of the list of nodes necessary to traverse all nodes on the list; and means for distributing the software updates to the nodes on the list using the set of traversals.

Example 27 is the apparatus for computing of example 26, and/or other examples herein, wherein the network is a sensor mesh network, and wherein the software update includes a firmware update for one or more sensors disposed at each network node on the list.

Example 28 is the apparatus for computing of example 26, and/or other examples herein, wherein the software update is a firmware update, and further comprising means for signaling all of the nodes on the list, prior to distribution of the update, to transition the nodes on the list into a firmware over the air (FOTA) progress state.

Example 29 is the apparatus for computing of example 26, and/or other examples herein, wherein the nodes on the list include both intermediate nodes with descendant nodes and leaf nodes without descendant nodes, and the means for distributing is further to distribute the software update to the leaf nodes through the intermediate nodes, the software update including provision of instruction to an intermediate node to distribute the software update to its descendant nodes.

Example 30 is the apparatus for computing of example 29, and/or other examples herein, further comprising means for traversing an intermediate node that branches into two or more descendant nodes just once.

Example 31 is the apparatus for computing of example 29, and/or other examples herein, further comprising means for instructing intermediate nodes on the list to cache the update, and means for instructing intermediate nodes that are not on the list, but that have descendant nodes that are on the list, to forward the update.

Example 32 is the apparatus for computing of example 26, and/or other examples herein, wherein the nodes on the list are a subset of all of the nodes in the network.

Example 33 is the apparatus for computing of example 26, and/or other examples herein, wherein the nodes in the network have a tree-mesh toplogy.

Example 34 is the apparatus for computing of example 33, and/or other examples herein, wherein the nodes on the list include both leaf nodes and intermediate nodes, on one or more branches of the tree-mesh topology.

Example 35 is the apparatus for computing of example 26, and/or other examples herein, further comprising means for performing network discovery prior to identifying the set of traversals to the leaf nodes of the list of nodes necessary to traverse all nodes on the list.

Example 36 is an apparatus for computing, comprising: means for receiving a FW update and a list of network nodes to be updated; means for identifying intermediate nodes, leaf nodes and parent branching nodes on the list; and means for distributing the update to all nodes on the list using a set of traversals to the leaf nodes on the list, wherein the set of traversals is such that a unique branch descending from a parent branching node is traversed just once.

Example 37 is the apparatus for computing of example 36, and/or other examples herein, further comprising, means for calculating, for the nodes on the list, a route and a number of hops to the node.

Example 38 is the apparatus for computing of example 37, and/or other examples herein, further comprising means for identifying the routes with the greatest number of hops (GNH routes), and means for deleting routes that cover a set of nodes included in a GNH route.

Example 39 is the apparatus for computing of example 38, and/or other examples herein, further comprising means for identifying parent branching nodes on the GNH routes, and means for combining GNH routes that share an identical path to the parent branching node so as to only traverse a path to the parent branching node once.

Example 40 is the apparatus for computing of example 36, and/or other examples herein, further comprising means for signaling all of the nodes on the list, prior to distributing the FW update, to transition into a firmware over the air (FOTA) progress state; and following distribution of the update, means for signaling all of the nodes in the network with a FOTA-complete-verify transmission.

What is claimed is:

1. An apparatus for selectively delivering software updates to nodes in a network, comprising:
a receiver to receive a software update and a list of nodes of the network scheduled to receive the software update; and
a device management agent (DMA), to:
identify a set of traversals to leaf nodes of the list of nodes necessary to traverse all nodes on the list, and
distribute the software update to the nodes on the list using the set of traversals.

2. The apparatus of claim 1, wherein the network is a sensor mesh network, and wherein the software update includes a firmware update for one or more sensors disposed at each network node on the list.

3. The apparatus of claim 1, wherein the software update is a firmware update, and wherein the DMA is further to signal all of the nodes on the list, prior to distributing the update, to transition the nodes on the list into a firmware over the air (FOTA) progress state.

4. The apparatus of claim 1, wherein the nodes on the list include both intermediate nodes with descendant nodes and leaf nodes without descendant nodes, and the DMA is further to distribute the software update to the leaf nodes through the intermediate nodes, including provision of instruction to an intermediate node to distribute the software update to its descendant nodes.

5. The apparatus of claim 4, wherein the DMA is further to traverse an intermediate node that branches into two or more descendant nodes just once.

6. The apparatus of claim 4, wherein the DMA is further to instruct intermediate nodes on the list to cache the update, and instruct intermediate nodes that are not on the list, but that have descendant nodes that are on the list, to forward the update.

7. The apparatus of claim 1, wherein the nodes on the list are a subset of all of the nodes in the network.

8. The apparatus of claim 1, wherein the nodes in the network have a tree-mesh toplogy.

9. The apparatus of claim 8, wherein the nodes on the list include both leaf nodes and intermediate nodes, on one or more branches of the tree-mesh topology.

10. The apparatus of claim 1, wherein the DMA is further to perform network discovery prior to identification of the set of traversals to the leaf nodes of the list of nodes necessary to traverse all nodes on the list.

11. The apparatus of claim 1, wherein the DMA is further to, following distribution of the update, signal all of the nodes in the network with a FOTA-complete-verify transmission.

12. The apparatus of claim 1, wherein the network is a mesh network, and the apparatus is a gateway of the mesh network, the gateway having the receiver and the DMA.

13. One or more non-transitory computer-readable storage media comprising a set of instructions, which, when executed on a network gateway (NG) coupled to a network of nodes, cause the NG to:
receive a firmware (FW) update and a list of destination nodes (DNs) that are to receive the FW update;
identify a set of traversals to leaf DNs that traverses all of the DNs, wherein if there are two possible traversals to a DN, the traversal with the fewest hops is included in the set; and
distribute the update to the destination nodes according to the set of traversals.

14. The one or more non-transitory computer-readable storage media of claim 13, wherein the network is a sensor network having either a tree-mesh toplogy or a mesh topology, and wherein the FW update includes an update for one or more sensors disposed at each DN.

15. The one or more non-transitory computer-readable storage media of claim 13, wherein the network includes at least one intermediate node that branches into two or more branches (parent branching node) that include DNs and wherein the set of traversals is such that the at least one parent branching node is traversed just once.

16. The one or more non-transitory computer-readable storage media of claim 15, further comprising instructions, that when executed, cause the NG to instruct at least one the parent branching node to distribute the update to its descendant nodes.

17. The one or more non-transitory computer-readable storage media of claim 13, further comprising instructions that, when executed, further cause the NG to signal all of the DNs, prior to distributing the update, to transition into a firmware over the air (FOTA) progress state.

18. The one or more non-transitory computer-readable storage media of claim 13, further comprising instructions that, when executed, further cause the NG to perform network discovery prior to identification of the set of traversals to leaf nodes to traverse all DNs on the list.

19. The one or more non-transitory computer-readable storage media of claim 13, further comprising instructions that, when executed, further cause the NG to instruct intermediate nodes on the list to cache the update, and intermediate nodes not on the list, but on a traversal path to another node that is on the list, to forward the update.

20. The one or more non-transitory computer-readable storage media of claim 13, further comprising instructions that, when executed, further cause the NG, following distribution of the update, to signal all of the nodes in the network with a FOTA-complete-verify transmission.

21. A method of determining a set of traversals to leaf nodes in a network, comprising:
receiving a FW update and a list of network nodes to be updated;
identifying intermediate nodes, leaf nodes and parent branching nodes on the list; and
distributing the update to all nodes on the list using a set of traversals to the leaf nodes on the list, wherein the set of traversals is such that a unique branch descending from a parent branching node is traversed just once.

22. The method of claim 21, further comprising, for the nodes on the list, calculating a route and a number of hops to the node.

23. The method of claim 22, further comprising identifying the routes with the greatest number of hops (GNH routes), and deleting routes that cover a set of nodes included in a GNH route.

24. The method of claim 23, further comprising identifying parent branching nodes on the GNH routes, and combining GNH routes that share an identical path to the parent branching node so as to only traverse a path to the parent branching node once.

25. The method of claim 21, further comprising:
signaling all of the nodes on the list, prior to distributing the FW update, to transition into a firmware over the air (FOTA) progress state; and
following distribution of the update, signaling all of the nodes in the network with a FOTA-complete-verify transmission.
